(19) United States
(12) Patent Application Publication
(10) Pub. No.: US 2026/0050827 A1
(43) Pub. Date: Feb. 19, 2026

(54) User Interface for Revising Model Generated Documents

(71) Applicant: Google LLC, Mountain View, CA (US)

(72) Inventors: Natalie Elizabeth Gross, London (GB); Lior Zur, Tel Aviv (IL)

(21) Appl. No.: 18/808,997

(22) Filed: Aug. 19, 2024

(51) Int. Cl. G06N 20/00

(52) U.S. Cl. CPC G06N 20/00

(57) ABSTRACT

The present disclosure provides computer-implemented methods, systems, and devices for generating outlines based on a source document. A computing device obtain input data, wherein the input data comprises source content that comprises a set of details associated with a topic. The computing device processes the input data with a generative model to generate one or more candidate model-generated outputs. The computing device displays a respective candidate model output in a user interface, wherein the user interface includes visual indicia of one or more signals associated with content in the candidate model output. The computing device receives augmentation input based on interaction with the user interface. The computing device updates the displayed respective candidate model output based on the augmentation input.

### FIELD

The present disclosure relates generally to providing a user interface for generating and utilizing a domain-specific generative model. More particularly, the present disclosure relates to tuning a generative model for domain-specific content generation to create model-generated content items with one or more domain-specific attributes.

### BACKGROUND

Large language models or other machine-learned models can be utilized for the realistic generation of natural language content, which can be trained on large training datasets, including diverse language instances. However, users may be reluctant to employ large-language models in certain circumstances because the generated language outputs may fail to meet domain-specific requirements, which may cause issues with readability, reliability, trust, and other quality metrics. Specifically, large language models may generate errors, including fabricated facts and/or sources.

### SUMMARY

Aspects and advantages of embodiments of the present disclosure will be set forth in part in the following description, or can be learned from the description, or can be learned through practice of the embodiments.

One example aspect of the present disclosure is directed to a computing system for generating outlines based on a source document. The system can include one or more processors and one or more non-transitory computer-readable media that collectively store instructions that, when executed by the one or more processors, cause the computing system to perform operations. The operations can include obtaining input data, wherein the input data comprises source content that comprises a set of details associated with a topic. The operations further comprise processing the input data with a generative model to generate one or more candidate model-generated outputs. The operations further comprise displaying a respective candidate model output in a user interface, wherein the user interface includes visual indicia of one or more signals associated with content in the candidate model output. The operations further comprise receiving augmentation input based on interaction with the user interface. The operations further comprise updating the displayed respective candidate model output based on the augmentation input.

Another example aspect of the present disclosure is directed to a non-transitory computer-readable medium storing instructions that, when executed by one or more computing devices, cause the one or more computing devices to perform operations. The operations can include obtaining input data, wherein the input data comprises source content that comprises a set of details associated with a topic. The operations further comprise processing the input data with a generative model to generate one or more candidate model-generated outputs. The operations further comprise displaying a respective candidate model output in a user interface, wherein the user interface includes visual indicia of one or more signals associated with content in the candidate model output. The operations further comprise receiving augmentation input based on interaction with the user interface. The operations further comprise updating the displayed respective candidate model output based on the augmentation input.

Another example aspect of the present disclosure is directed to a computer-implemented method for generating outlines based on a source document. The method can comprise obtaining, by a computing system comprising one or more processors, input data, wherein the input data comprises source content that comprises a set of details associated with a topic. The method further comprises processing, by the computing system, the input data with a generative model to generate one or more candidate model-generated outputs. The method further comprises displaying, by the computing system, a respective candidate model output in a user interface, wherein the user interface includes visual indicia of one or more signals associated with content in the candidate model output. The method further comprises receiving, by the computing system, augmentation input based on interaction with the user interface. The method further comprises updating, by the computing system, the displayed respective candidate model output based on the augmentation input.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example content generation system for providing model output in a user interface according to example embodiments of the present disclosure;

FIG. 2 represents an example content generation system 100 for receiving user feedback on the output of a model and generating an updated output based on that feedback according to example embodiments of the present disclosure;

FIG. 3 represents a flow diagram for a process that uses a generative model to enable a user to create a draft of a document based on a source document in accordance with example embodiments of the present disclosure;

FIG. 4 describes an example flow for generating an article based on an outline in accordance with example embodiments of the present disclosure;

FIG. 5 is an example table representing the signals available to the user interface in accordance with example embodiments of the present disclosure;

FIG. 6A illustrates an example of the user interface flow when converting an outline of a document to a completed draft of that document in accordance with the example embodiments of the present disclosure;

FIG. 6B is an illustrative example of a user interface flow when converting an outline of a document to a completed draft of that document in accordance with the example embodiments of the present disclosure;

FIG. 6C is an illustrative example of a user interface flow when converting an outline of a document to a completed draft of that document in accordance with example embodiments of the present disclosure;

FIG. 6D is an illustrative example of a user interface flow when converting an outline of a document to a completed draft of that document in accordance with an example embodiment of the present disclosure;

FIG. 7A illustrates an example user interface for presenting an outline to the user for revisions before generating the complete draft in accordance with example embodiments of the present disclosure;

FIG. 7B illustrates an example user interface for presenting a full draft to the user for revisions before generating the complete draft in accordance with example embodiments of the present disclosure;

FIG. 7C illustrates an example user interface 760 for adding additional references for an outline in accordance with example embodiments of the present disclosure;

FIG. 8 illustrates an example user interface for presenting an outline in a user interface to allow for user revisions before generating the complete draft in accordance with the example embodiments of the present disclosure;

FIG. 9 illustrates an example user interface for presenting an outline to the user for revisions before generating the complete draft in accordance with the example embodiments of the present disclosure;

FIG. 10 depicts a block diagram of an example candidate model-generated content item selection system according to example embodiments of the present disclosure;

FIG. 11 depicts a block diagram of an example infrastructure system according to example embodiments of the present disclosure.

FIGS. 12A-12H depicts a user interface for generating documents using a machine-learned model in accordance with example embodiments of the present disclosure;

FIG. 13 depicts a flow chart diagram of an example method to perform according to example embodiments of the present disclosure.

FIG. 14 depicts a block diagram of an example computing system 1400 that performs domain-specific content item generation according to example embodiments of the present disclosure;

FIG. 15 depicts a block diagram of an example computing device that performs according to example embodiments of the present disclosure;

FIG. 16 depicts a block diagram of an example computing device that performs according to example embodiments of the present disclosure; and

FIG. 17 depicts a flow diagram of an example process for adding additional sources to a system for content generation system 100 according to example embodiments of the present disclosure.

Reference numerals that are repeated across plural figures are intended to identify the same features in various implementations.

### DETAILED DESCRIPTION

Generally, the present disclosure is directed to systems and methods for presenting the output of a generative model that can be displayed in a user interface to enable users to make alterations to the generated content. In particular, when users employ a generative model to generate a document, it can be difficult to quickly and accurately determine which updates need to be made. As a result, users either accept the output of the generative model without significant alterations or have to supply a substantial amount of work to customize the output such that the benefit of the generative model is significantly reduced. In this example, the user interface presents the output of the generator model to the user such that it can be easily updated or altered by the user. Specifically, the general model can generate an outline of an article based on some source content. The outline can emulate styles, tones, and/or terminology of news articles generally or that of a specific user/publisher. For example, the generative model can generate an outline of an article that summarizes a press release. The outline (and draft) can include features of news articles, such as a lede that provides specific information (who, what, where, when, why, and how). The article can also follow the inverted pyramid structure common in journalism.

For example, the generative model can generate an article outline summarizing the press release. The user interface displays information about the text, including information describing the results of one or more signals generated by the generative model. The user can alter or rearrange the outline as desired. Once the user has completed any revisions of the outline, the generative model can convert the outline into a complete document.

In some cases, a user can request a generated document based on a particular content source (e.g., a source document or other source content). The content generation system can receive the content source and generate input for a generative model based on the content source. The input to the model can be a prompt that includes the content source. In some examples, the prompt can indicate the type of document to produce. For example, if the document to be created is an article based on a press release or other source, the prompt can include information about the format and style of such press releases. The generative machine learning model can produce a model output in response to the input. In some examples, the output can be an outline for an article.

The output can be displayed in our user interface for presentation to a user. The user interface can include a plurality of sections for the outline, including one section that includes a lede. In some examples, the interface can also display the source document from which the outline is generated. For example, the user interface can display the source document and the outline side by side. The interface can include information enabling the user to determine which parts of the outline came from which parts of the source document. In other examples, once the system has generated a full draft, the source document and the final draft can be displayed side-by-side, and the interface can include visual indicia informing the users, for a plurality of portions of the draft, the source of the information of those portions in the source document.

The content generation system can also generate information about various portions of the output called signals. In some examples, these signals are generated by specific models trained to analyze text and generate signal data for one or more signals with respect to the text. One example can be a grounding model. The grounding model can be a machine-learned model (e.g., a natural language inference model (NLI)) LLM model trained to analyze the output of a generative model and generate signal data about the grounding (or other features) of one or more portions of text. The value of a grounding signal can represent the degree to which the source document supports a particular portion of text in the output of the generative model. Other models can be used to generate data for different signal types, as discussed below.

These signals can determine various issues that may be associated with particular portions of the text. For example, some signals may be associated with full sentences of text, while other signals are associated with smaller sections of text (e.g., spans). The signals may indicate to users that particular portions of text have specific characteristics. The characteristics can be positive or negative. The signals can include a grounding signal, a verbatim signal, a quotation signal, an entity signal, a recitation signal, a granular grounding signal, a sensitivity signal, and/or other signals. A plurality of portions of text can be evaluated to determine a score for each signal type. For example, a portion of text may have low scores for most of the signals but a high value for the verbatim signal, indicating the portion of text may be similar to text in another known source. The portion of text can be highlighted using visual indicia associated with the verbatim signal.

Each signal can have an associated threshold value. The threshold value can represent a signal score at which the associated portion of text is determined to be associated with the signal. The document generation system can determine whether the value for any signal exceeds the associated threshold value for each portion of text. If any portion of the text exceeds the signal threshold for a respective signal, the document generation system can determine that the portion of text is flagged for that respective signal. In some examples, the signals can be associated with a negative characteristic, and portions of text determined to have that characteristic can be flagged using visual indicia in the user interface to be reviewed or changed by the user. In other examples, the signal can be associated with a positive characteristic (e.g., the portion of text is well-grounded in the source text). In this example, the portion of text can be flagged using visual indicia in the user interface to indicate that the text portion may need less user attention.

In some examples, visual indicators can be displayed in the outline (or full draft) to include visual indicators that communicate the particular signal for which the text portion fails to satisfy the threshold. For example, one or more portions of the text can be highlighted or underlined with a highlight color or style associated with a particular signal.

In addition to the visual indicators displayed over the text of the draft or outline, the user interface may also include a visual reference back to the relevant part in the source document that is displayed side-by-side with the draft or outline, allowing users to quickly determine whether any changes should be made based on the specific signal. For example, if a portion of text is supported by a specific portion of text in the source document, the interface can have a line or arrow connecting the portion of text in the outline or draft to the relevant portion of the source document. This visual indicator can significantly reduce the time needed by the user to review the source document to evaluate the issue indicated by the signal.

In another example, if a portion of text is determined to be an incorrect quote (based on a high incorrect quote signal score), the user interface can include a visual indication (e.g., a line, an arrow, and so on) connected the portion of text with an incorrect quote to the correct quote (or the closest fitting text) in the source document. Again, this can reduce the time needed for the user to evaluate the incorrect quote signal by allowing the user to immediately review the relevant portion of the source document rather than finding it themselves.

In some examples, a particular portion of text may be flagged for more than one signal. In some examples, the document generation system can use a predetermined policy to determine which of the signals should be displayed to the user in the interface.

For example, if a sentence is flagged as both an “accurate quote” and “verbatim from source,” the “accurate quote” signal would take precedence as it is a more unique/precise signal, and in this case, permissible rather than problematic verbatim. In this way, the document generation system may determine only to display visual indicators for one signal. In some examples, each signal may have an importance value. If so, the document generation system can select the signal with the highest importance value to display to the user using visual indicators in the user interface.

The marked-up version can be displayed in the mark-up interface to indicate which portions may have potential issues (e.g., verbatim language, inaccurate quotes, a problematic recitation (e.g., a recitation from a third-party source which isn't the source used (e.g., from the web)), incorrect and/or lack of attribution, and/or which portions have factual grounding, proper recitation, and/or other evaluation signals. The mark-up interface can then be utilized to show portions that may need to be edited. The visual indicators can include highlights, underlining, and so on. In some examples, the user interface can include a written explanation of the specific issue with a particular portion of text. In some examples, the user interface can include a legend that explains the specific colors and/or visual indicators associated with each signal.

The user interface can receive feedback from the user. That feedback can include direct edits to the text, reorganizing the portions of the outline, correcting sourcing errors, and so on. In some examples, the displayed version of the outline includes information connecting portions of the outline to particular portions of the source document. The feedback from the user can include updates to the sourcing of specific facts and the addition of information not included in the outline.

Once the user has finished editing the outline presented in the user interface, the user can indicate that the outline is prepared for use in generating articles. In response, the system can generate a full article from the edited outline. In other examples, the outline can be organized into a plurality of sections. Each section can represent one or more paragraphs of the final document. The user can complete and approve each section individually. To do so, the user can indicate that a particular section is ready to be converted into a draft. For example, the user interface can include a “generate this section” interface button. The document generation system can generate the document section-by-section. In another implementation, the user can edit and approve all the sections simultaneously. For example, the interface can include a “Generate” button associated with all sections of the outline. In this case, the document generation system can generate a draft for all the sections at once. The user can review the final generated draft to identify any remaining issues or problems that need to be fixed.

In some examples, the generated draft sections can be added to the full draft based on user input. For example, the user can edit the outline, receive a generated paragraph for each section, edit the generated paragraphs, and add each paragraph to the final draft of the document. Once the user has added each section of the proofread document to the final document, the document generation system can finalize it and provide it to the user.

The user interface can be utilized by users who generate content for publishers (e.g., newspapers and/or news aggregators) to interact with generated content items (e.g., news articles) effectively to control the content before it the final draft is generated (e.g., style, structure, citation formatting, facts contained, sources used, and/or terminology). The content generation system enables the users to have more direct control over the output of a generative model and reduces the need to regenerate the content in response to user feedback. In addition, the signal data that is displayed can enable users to identify and respond to issues in the content generated by the content generation system more quickly and efficiently. Generally, the content generated by a sequential processing model (or other generative models) can include factual errors (or other mistakes) that may be difficult to identify without the visual indications in the user interface. Manually verifying every detail/phrase in a generated article or outline can be very onerous. Thus, the signal indicators in the user interface can significantly reduce the time needed to check the document and increase the likelihood of issues being identified. As a result, the generated documents are less likely to include the issues represented by the signal data while reducing the time needed to produce the document.

Presenting visual indications of possible issues within the outline (or full draft) text enables users to efficiently identify and resolve potential issues, reducing time and cost using these tools. In addition, the tools provided by the user interface enable a user to feel increased control over the generation of content by the model. This can result in users being more willing to use the generative model for some tasks.

The systems and methods of the present disclosure provide a number of technical effects and benefits. As one example, the system and methods can be utilized by users to generate content with reduced time and effort, while still retaining full control of the content itself. Specifically, the process includes displaying an outline for the user to review. This allows the user to review the content and make any changes the user wishes. The interface can also include visual indicators that highlight potential issues with the outline (or draft) and provide a visual indicator that indicates the source of information in the source content. Together, these tools can significantly reduce the time needed to produce high-quality content while enabling the user to reduce potential errors effectively. This gives the users more direct control over the output of a generative model and reduces the need to regenerate the content in response to user feedback. This reduces power usage and processor usage.

Another example of technical effect and benefit can include presenting visual indications of possible issues within the outline text to enable a user to efficiently identify and resolve potential issues, reducing time and cost using these tools. In addition, the tools provided by the user interface enable a user to feel increased control over the generation of content by the model. This can result in users being more willing to use the generative model for some tasks.

Another example of technical effect and benefit relates to improved computational efficiency and improvements in the functioning of a computing system. For example, a technical benefit of the systems and methods of the present disclosure is the ability to reduce the computational resources needed for training and/or tuning a generative model for generating high-quality outputs for downstream tasks with domain-specific and user-specific attributes. In particular, the generative language model can be utilized to generate domain-specific content items that emulate styles, tones, and/or terminology identified as being user/publisher-specific. In some implementations, the generative language model and/or one or more soft prompts (e.g., a set of machine-learned parameters that can be processed with the input by the generative language model) can be trained to emulate the tone, style, and/or vocabulary of a particular domain, a particular user, and/or a particular set of users (e.g., a publishing group).

With reference now to the Figures, example embodiments of the present disclosure will be discussed in further detail.

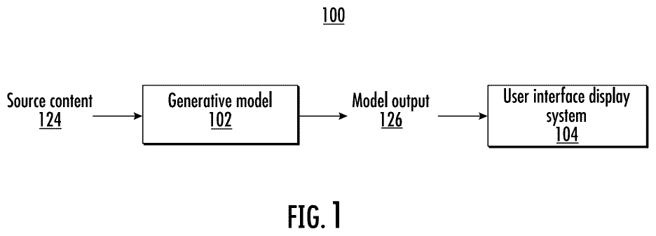

FIG. 1 depicts a block diagram of an example content generation system 100 for providing model output 126 in a user interface according to example embodiments of the present disclosure. In some implementations, the generative model 102 is configured to receive or obtain source content 124 that includes content associated with a particular subject or event. Thus, in some implementations, the content generation system 100 can include a generative model 102 that is operable to perform a plurality of predictions to generate model output 126.

In particular, the generative model 102 can obtain source content 124 to generate output (e.g., a news article). In some examples, the source content 124 can be provided by a user. In some examples, the content generation system can recommend source content 124. In other examples, the user can provide the source content 124, and the document generation system can provide recommendations for additional adjacent sources that can be incorporated into the outline/draft. For example, the content generation system 100 can receive the source content 124 from the user and recommend adjacent sources for incorporation into the outline and/or draft.

The source content 124 can be any media content that includes information about a particular subject. For example, the source content 124 can be a press release from an organization providing information about a particular event or topic. The user can provide the source content 124 along with a request to generate a document based on the source content 124. The input to the generative model 102 can be a prompt that includes the source content 124 and any style requests from the user. This prompt can be provided to the generative model 102. The request can be included in a prompt with directions for one or more requested attributes for the model output. For example, the attributes can include one or more journalistic-specific attributes, including the structure, terminology, and factual pattern layout typical of journalism content.

The generative model 102 can be trained or fine-tuned using content from a specific domain of content items. For example, if a generative model 102 is intended to be used to create news articles, the generative model 102 can be trained using a plurality of news articles that may include one or more journalistic-specific attributes, including the structure, the terminology, and factual pattern, layout typically used in news articles. In particular, the one or more domain-specific attributes can include an order of content, which may include a lede before the background information. The lede can summarize a key aspect of a story in an opening sentence or paragraph.

The plurality of input examples can include a plurality of press releases (and/or enrichment materials (e.g., interview transcripts)) associated with the plurality of news articles. For example, the plurality of press releases (and/or the enrichment materials (e.g., interview transcripts)) can be a brief statement of facts on respective stories. The plurality of news articles can include full-length news articles that include at least a subset of the facts of the brief statements of facts on respective stories.

The generative model 102 can generate model output 126 in response to the prompt. The model output can be a proposed outline of an article based on the content source. For example, if the source content is a press release, the model output can be an outline of an article describing the content of the press release. In some examples, the generative model can generate a plurality of potential outlines. Each outline can be evaluated based on a variety of factors, including quality, number of errors, readability, the degree to which it matches the characteristics requested by the user, and so on. The outline with the highest overall score can be selected and displayed to a user.

The user interface can have a plurality of sections. For example, the original source content 124 can be displayed in one section of the interface. Next to the original source content 124, the outline can be displayed. The outline may be divided into a plurality of sections representing different paragraphs or portions of the proposed article. For example, the first section can be the lead. Subsequent sections can represent each paragraph in the proposed article, with bullet points describing the content of that paragraph.

In some examples, the displayed outline can be annotated with visual indications representing one or more qualities of the underlying text. For example, the generative model 102 can also produce information representing signals associated with the text. The signals can include information describing characteristics of one or more portions of the text, including grounding, length, recitation, attribution, verbatim, and so on. This information can be provided to the user interface display system for display to the user.

The user interface display system can then provide indications in the text for issues the user may want to be aware of. A section with a low grounding signal score may be highlighted or underlined. Similarly, a section with a high verbatim signal score (e.g., it closely tracks the text from another source) can be visually indicated to the user. Highlighting in this way can allow the user to easily identify the verbatim portions of the proposed article and determine whether those portions are intended to match the source content so closely. If this close matching is undesirable, the user can easily determine which portions of the proposed outline to change.

The display user interface can provide the user with tools to submit changes to the proposed outline. For example, the user can edit the proposed outline to rearrange the order of the sections, add missing sections or remove unneeded sections, add or remove text, delete inappropriate content, and so on. The user interface itself may include indications that match portions of the outline with the particular sections of the source content from which it was drawn. These indications can enable the user to review the text more efficiently and identify problems more clearly.

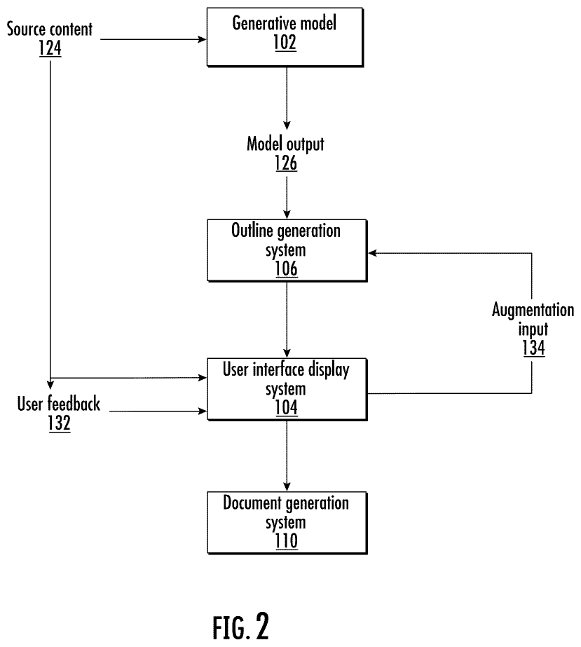

FIG. 2 represents an example content generation system 100 for receiving user feedback on the output of a model and generating an updated output based on that feedback according to example embodiments of the present disclosure. In this case, the content generation system 100 can receive source content 124 from a user. In other examples, the content generation system 100 can access the source content 124 without express user submission. For example, if the user asks the system to find appropriate source content for a particular article subject. In addition, the content generation system 100 can make automatic suggestions without a specific user request. For example, the content generation system 100 can, with the permission of the user, access user information stored in a user profile. Based on the user information, the content generation system 100 can suggest particular source content documents to the user based on determined subjects of interest.

As discussed above, the source content 124 can be information intended to be used to generate a news article, such as a press release. However, other sources for the source content 124 can be used. The source content 124 can be provided as input to the generative model 102. For example, the source content 124 can be included in a prompt provided to the generative model 102.

In some examples, the generative model 102 has been trained with a domain-specific data set to provide content with particular characteristics. For example, a generative model 102, trained on news articles, will produce output with characteristics associated with news articles, including one or more journalistic-specific attributes (e.g., the structure, the terminology, and the factual pattern layout associated with new articles). In particular, the one or more domain-specific attributes can include an order of content, which may include a lede before the background information.

In some examples, the generative model 102 can provide the model output 126. This model output can be an outline for a proposed news article. In some examples, the output from the generative model 102 includes a plurality of potential outlines. An evaluation system can evaluate each outline to determine the best candidate from the plurality of outlines output by the generative model 102. In other examples, the generative model 102 can output a plurality of completed articles. These articles can be provided as model output 126 and the outline generation system 106 can generate outlines based on the completed article(s).

The model output 126 can be provided to the outline generation system 106. As mentioned above, the model output may already be in outline format. In other examples, the model output 126 from the generative model 102 is not in an outline format. The outline generation system 106 can generate an outline from the model output 126. An outline format can include a lede, which is an opening sentence or idea followed by a plurality of proposed paragraphs, with each proposed paragraph including one or more bullet points of information to be discussed in the paragraph.

Once the outline generation system 106 has generated the outline, the outline can be transmitted to the user interface display system 104. The user interface display system 104 can also receive source content 124. The source content 124 and the generated outline can be presented in the user interface display system 104. In some examples, the source content 124 and the generated outline can be displayed next to each other so the user can easily view both documents simultaneously.

If both the source content 124 and the generated outline are displayed, the user interface display system 104 can display user interface elements that illustrate which parts of the generated outline were generated from particular parts of the source content 124. For example, the user interface can include information that describes to the user which parts of the outline came from which parts of the source content 124. Displaying the connections between source content 124 and the generated outline can enable quicker and more accurate user review. The user interface display system 104 can display visual indicators of a variety of factors associated with the outline. This additional information can include a plurality of signals. The signals can include information describing a score that ranks each portion of text based on its grounding, recitation, attribution, accuracy, verbatim, and so on. The user interface display system 104 can include criteria for when to display a visual indication associated with a particular signal. For example, the user interface display system 104 may include a predetermined threshold score for low grounding. Thus, any portion of the text with a low grounding signal score below the predetermined threshold can be highlighted (or otherwise visually indicated with the user interface) to alert the user of a potential problem (lack of grounding).

Once the user interface is updated with this additional information, the outline generation system 106 can receive the additional information. This additional information can be received as augmentation input 134. Augmentation input 134 from the user can include the information received from the user indicating particular edits to be made to the currently displayed outline. The augmentation input 134 can describe a request to augment the model-generated outline. The augmentation input 134 can include changes to the wording or order of particular bullet points, changes to the order of the paragraphs, removal of unnecessary information in the outline, or addition of additional information not currently displayed in the outline.

In some examples, once the augmentation input 136 has been received, the outline generation system 106 can update the text displayed in the user interface based on the augmentation input 136. For example, the augmentation input can include edits to correct an incorrect quote. As the user provides editing input, the outline is updated to reflect the edits made by the user. This process can be repeated until the user approves the displayed outline.

Once the user has approved the outline displayed in the user interface system, the user can approve the draft, and the draft outline can be transmitted to the document generation system 110. The document generation system 110 can generate a full document based on the approved outline. In some examples, the outline generation system 106 can also access the generative model 102 to produce a final draft of the document.

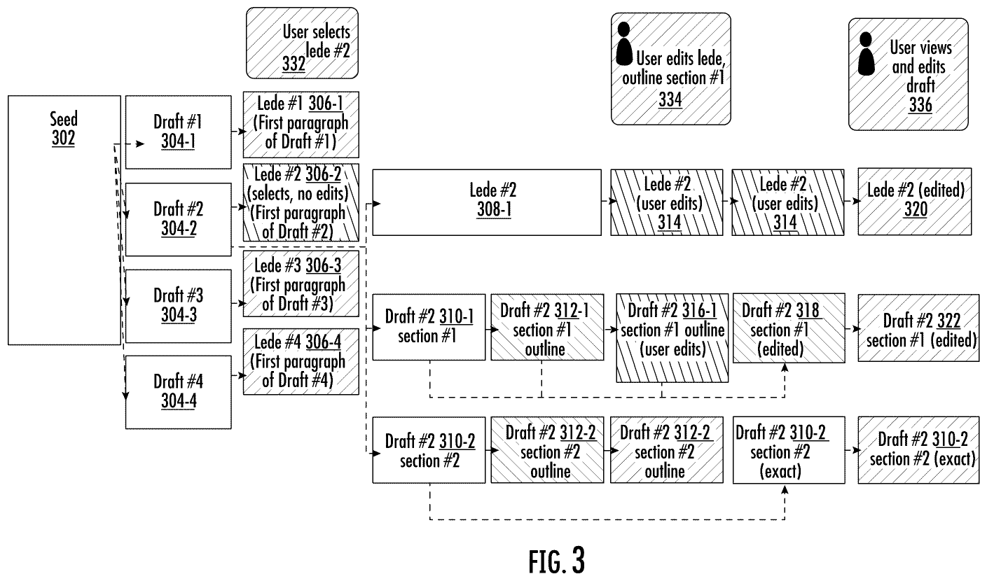

FIG. 3 represents a flow diagram for a process that uses a generative model to enable a user to create a draft of a document based on a source document in accordance with example embodiments of the present disclosure. For example, a content generation system (e.g., content generation system 100 in FIG. 2) can access a seed 302 (e.g., source content 124 in FIG. 1). As discussed in previous figures, the seed 302 can be provided by a user or recommended by the content generation system (e.g., content generation system 100 in FIG. 2). The generative model 102 can use this seed to generate a plurality of outputs. Each output can be a draft of a document (e.g., an article). In this example, the output includes four drafts. The four drafts are draft 1 through draft 4 (304-1 to 304-4). The system can present a portion of each candidate draft to the user. The user can select their preferred draft. In some examples, the user can select based on ledes associated with each draft. For example, the portion of each draft shown to the user is the lede (e.g., 306-1 to 306-4). The user can, at 332, select a lede from the displayed ledes. However, in other examples, the system can choose the particular draft to use itself without presenting it to the user based on one or more quality metrics.

In some examples, the model output can be an outline of a particular document to be generated. Each outline can have a plurality of sections. The sections can include a lede section and one or more body sections. The body sections can each represent a paragraph to be included in the final draft, while the lede section includes the lede (e.g., the initial sentence of the article that summarizes one or more of the most important aspects of the article). The content in the lead and the sections can be presented in bullet form.

In some examples, the draft can be a fully drafted document. The outline generation system (e.g., outline generation system 106 in FIG. 2) can generate an outline based on a complete draft. Once the user selects a specific lede (e.g., based on an interaction with the interface using a mouse or touch screen), the associated outline can be displayed to a user in a user interface.

In this example, the user has selected lede 2 (306-2). Based on this selection, the system can display all or a portion of lede 2 (308-1). In addition, the system can access a first section (310-1) and a second section (310-2) of the outline associated with lede 2 (308-1). The outline generation system 106 can generate a section 1 outline (312-1) based on the first section (310-1) and a section 2 outline (312-2) based on the second section (310-2) . The section 1 outline (312-1) and the section 2 outline (312-2) can be displayed in the user interface for user review.

The user can edit various aspects of the outline, including the lede, the specific wording, and the order of the multiple sections, removing or adding details, as necessary. The sections can be updated based on the user's feedback.

In this example, the user can, at 334, provide edits to the lede and section 1 outline (312-1). The user can make edits by interacting with the text of the lede (314) in the user interface to add or remove content. Similarly, the user can edit the text in the section 1 outline (316-1). The outline generation system can update the first section based on the user edits and generate an edited version of the section 1 outline 318 for display to the user. For example, the user makes direct edits to the text, and those edits are reflected in the displayed outline as the user makes them. In other examples, the user can provide instructions to the model that the model can use to update the displayed outline. The section 2 outline (312-2) remains unchanged (and thus has the same reference number) because the user did not edit the content in the section 2 outline.

Once the user has edited the outline as desired, the user can approve the outline. Once the user has approved the draft outline, a document generation system (e.g., document generation system 110 in FIG. 2) can generate a complete draft. In some examples, the document generation system 110 can use a generative model to generate a complete draft from the approved outline. In some examples, the draft can be generated on a piece-by-piece basis. For instance, as each section of the outline is approved, the draft generation system can generate the corresponding portion of a document for the respective approved section.

In this example, the document generation system can generate an edited lede 320 once the user has approved the edited lede. The generated lede 320 can represent the final version of the lede. Similarly, once the user approves the edited version of the section 1 outline 318, the document generation system 110 can generate a complete draft of the edited section 1 322. The document generation system 110 can generate the complete draft of section 1 322 based on the edited version of the section 1 outline 318.

Furthermore, once the user has approved the section 2 outline 312-2 (which the user did not edit), the document generation system 110 can produce a final draft that matches the original section 2 draft 310-2 because the user made no edits.

Once the document is generated, the document generation system 110 can present the final document to the user. The user can, at 336, view and make edits to the final draft as needed.

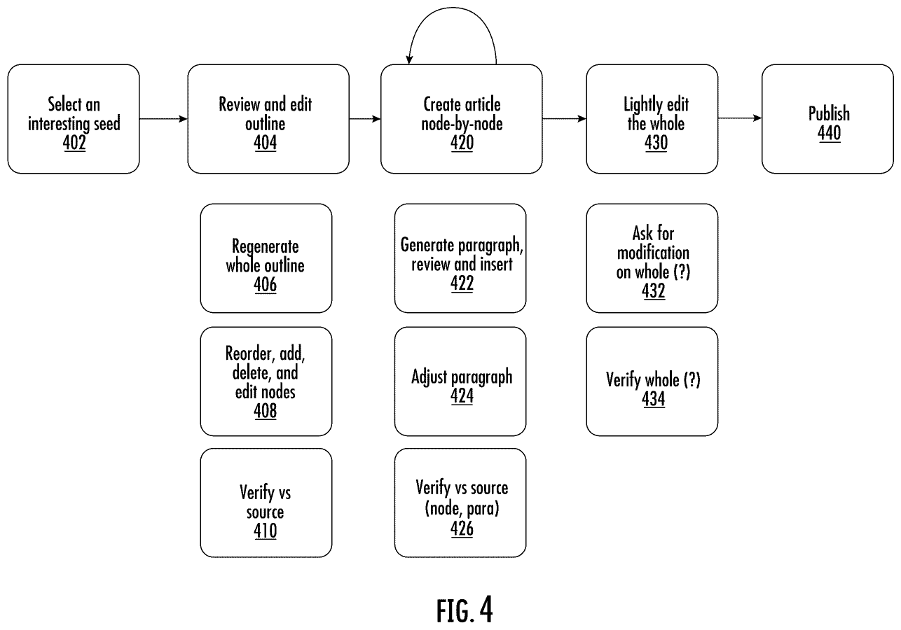

FIG. 4 describes an example flow for generating an article based on an outline in accordance with example embodiments of the present disclosure. The flow includes selecting an interesting content source for a particular article. In some examples, the source content is determined based on the user submitting an original piece of content. In some examples, the user can, at 402, select interesting content, and a generative model can generate a plurality of options to use as a seed for generating an outline. In some examples, the document generation system (e.g., document generation system 110 in FIG. 2) can automatically select the best option of the plurality of the generated seeds. In other examples, the document generation system 110 can display a plurality of seeds to the user, and the user can select one for use by the document generation system 110.

Based on the selected seed, the document generation system 110 can generate an outline of a document (e.g., an article) and present it to the user. The user can, at 404, review and edit the outline 404. During the review process, the interface enables the user to perform a variety of actions. Those actions can include, at 406, directing the generative model to regenerate the whole outline. Another action can include, at 408, reordering, adding, deleting, and editing content within the plurality of nodes. Another action can include, at 410, verifying the information in the outline against the information in the source. In some examples, the user interface can include visual indications that help the user quickly and accurately determine a source location for each item in the outline. In some examples, the source document can be displayed in the user interface. The user can use the source interface to verify the information in the outline against the original source document.

A generative model (e.g., generative model 102 in FIG. 1) can then create the article based on the outline that has been reviewed. In some examples, the outline includes a plurality of notes, each node representing a portion of the finished article. For instance, the first node can be the topic or lead node that includes information that describes the general idea of the article. The following nodes can be associated with a paragraph, and each paragraph can include a series of bullet points.

The generative model 102 can, at 420, generate the final draft based on the outline once the user approves it. The user may approve each node individually so that the user can review each node after it is generated in its complete form. In this case, the user can take a few actions in the user interface. For example, the user can, at 422, generate a paragraph for a node, review that paragraph, and insert or remove any content. The user can, at 424, adjust the paragraph (e.g., its location within the document or the content within the paragraph) until the user is happy with the generated paragraph. The user can also, at 426, verify the complete paragraph to ensure that the generated paragraph continues to reflect the source document accurately and that there are no discrepancies. For example, if the generated paragraph quotes the original source, the user can quickly determine that the quote is accurate.

Once all nodes have been processed to generate the complete form of the article, the user can, at 430, perform editing actions on the entire draft. For example, the user can, at 432, request (using a prompt) the generative model to make an overall change to the complete draft. For example, when viewing each draft paragraph individually, a user may not notice that a particular sentence structure is used frequently. However, when reviewing the entire draft, the user may detect the overuse of a particular sentence construction and request that the article generation system modify the draft to reduce its overuse. In some examples, the user can, at 434, verify the whole document to ensure that the individual paragraphs fit together in a way that is representative of the original document.

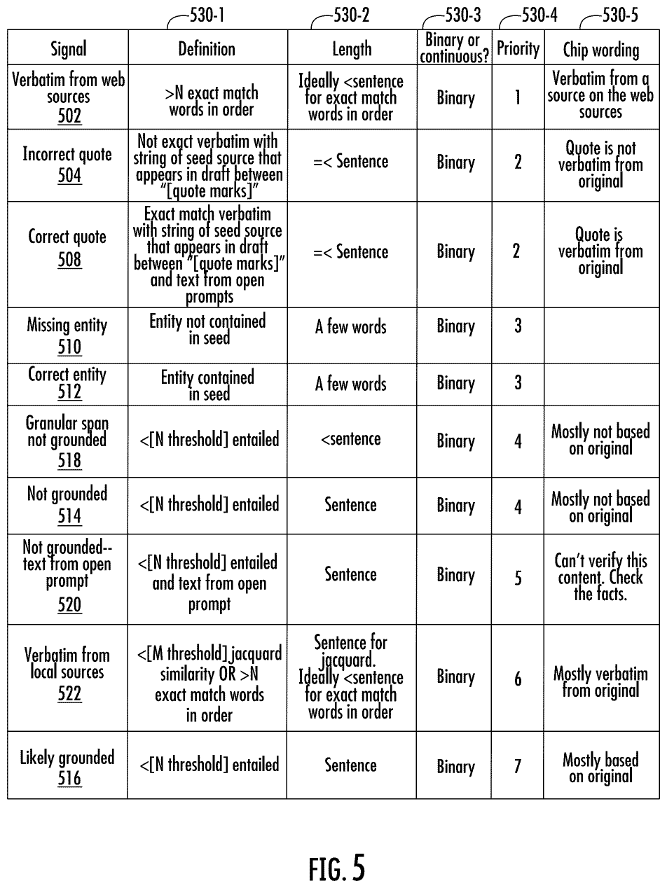

FIG. 5 is an example table representing the signals available to the user interface in accordance with example embodiments of the present disclosure. This table includes a list of different signals that can be generated by the generative model and provides information about each signal. Each signal represents a characteristic of the text included in a generated outline or generated document. For example, each sentence in an outline can have an associated value for each signal. The user interface can include visual indicia of any particular signals associated with a specific sentence.

The signals include a verbatim signal 502, an incorrect quote signal 504, a correct quote signal 508, a missing entity signal 510, a correct entity signal 512, a likely not grounded signal 514, a granular span not grounded signal 518, a not grounded—text from open prompt signal 520, verbatim from local sources 522, and a likely grounded signal 516. Each signal can have associated characteristic information. The characteristics of each signal include the definition of the signal 530-1, the length of the text portion for which the signal is applied 530-2, whether the signal is binary or continuous 530-3, the priority of the signal 530-4, and the wording on the chip used to notify the user of the meaning of the visual indicators 530-5.

In some examples, the verbatim signal 502 can be used to detect and avoid inadvertent potential plagiarism from web sources not utilized by the journalist. As such, the verbatim signal 502 can be defined as a predetermined number of words in a row (N) exactly matching content identified from another source (e.g., from information accessible on the Internet). As such, the length of text associated with this signal can be determined based on the number of words (N) selected. For example, the length could be set to a value such as 7, 9, 11, or another value. This signal is distinguished from the correct quote signal 508 based on the lack of quotation marks around the matching text. The verbatim signal 502 can be binary (e.g., true if an exact match with existing text and false if not). The verbatim signal 502 can have the highest priority value. In this example, the priority values are from one to seven (with one being the highest), and the verbatim signal can have a priority value of one. The verbatim signal 502 has a very high priority to ensure that the content generation system has a lower chance of producing documents that include plagiarized text without the user's knowledge. The wording (530-5) on the chip used to notify users that a portion of text is determined to be verbatim can be “Verbatim text, consider rephrasing.” In some examples, the alternative but related signal can be a verbatim based on local sources signal. A verbatim based on local sources signal can represent that the text is a verbatim reproduction of the text in the source document or another local document (e.g., provided by the user or suggested by the system). This signal may include a visual indication (e.g., an arrow or line) linking the verbatim text to the location in the local document where the matching phrase is found.

The incorrect quote signal 504 can be defined as representing a string of words within quotation marks that do not exactly match the text in the source document. Thus, the incorrect quote signal 504 can identify sections of text that appear to be a direct quote but do not accurately represent the material it is attempting to quote. The length of text associated with the incorrect quote signal 504 can be a sentence or less. The incorrect quote signal 504 can be binary (e.g., true if the text is surrounded by quotation marks but is not an exact match with the source content and false if the text is an exact match with the source content). The priority of the incorrect quote can be above average. In this example, the priority of signals is represented as a number between 1 and 7 (with one being the highest and seven being the lowest), and the incorrect quote signal 508 is assigned a 2. The chip 530-5 displayed in the user interface to alert the user of the issue may be “Quote is not verbatim from original” or “inaccurate quote.” In some examples, minor changes to the quote may result in false positives for the incorrect quote signal. For example, the capitalization of words may be slightly altered, or the grammar elements may be slightly altered to fit the quotation into the context of the generated document. Thus, the user interface can enable the user to inform the content generation system to confirm that the quote is correct.

The correct quotation signal 508 is defined (in the definition for the signal 530-1) as representing a determination that the text between two quotation marks is an exact match to a portion of text in the source content. The length of text associated with the quote signal 508 can be a sentence or less. The correct quotation signal 508 can be binary. Thus, the signal can be only one of two values. One of the possible values can indicate that the text in question is a correct quote (e.g., setting the signal to 1) and the other possible value can indicate that the associated text is not a correct quote (e.g., setting the signal to 0). The length of text associated with the correct quotation signal 508 can be less than or equal to a sentence. In some examples, the correct quotation signal 508 is only applied to text between two quotation marks in the outline. The priority of the correct quote signal 508 can be relatively high. In this example, the priority of signals is given a number between 1 and 7 (with one being the highest and seven being the lowest), and the correct quote signal 508 is assigned a 2. The chip 530-5 displayed in the user interface to alert the user of the issue may be “Quote is verbatim from original” or “correct quote.”

The missing entity signal 510 can be defined (as in the definition of the signal 530-1) as representing where an entity (person, place, organization, and so on) is missing from the source content. The missing entity signal 510 can be used to identify situations in which the generative model has incorrectly included information that is inappropriate for the outline. The length of text for which a missing entity signal 510 can be generated can be a few words. For example, the reference to an entity may use one word, and that word can be analyzed to generate a missing entity signal 510. The missing entity signal 510 can be binary (e.g., set to true if the text (e.g., a few words) represents an entity that is not represented in the source content and false if the text represents an entity that is described in the source content (or is not associated with a particular entity)). The priority of the missing entity signal 510 can be about average. In this example, the priority of signals is given a number between 1 and 7 (with one being the highest and seven being the lowest), and the missing entity signal 510 is assigned a 3. The chip 530-5 displayed in the user interface to notify the user that a particular entity is missing from the source may be one of “Date not in source,” “Number not in source,” “Location not in source,” “Person not in source,” or “Organization not in source.”

The correct entity signal 512 can be defined (as in the definition of the signal 530-1) as representing where an entity (person, place, organization, and so on) is present in the source content. The correct entity signal 512 can be used to confirm that a particular entity is included in the source content. The length of text that the correct entity signal 512 can be a few words. For example, the reference to an entity may use one word, and that word can be analyzed to generate a correct entity signal 512. The correct entity signal 512 can be binary (e.g., set to true if the text (e.g., a few words) represents an entity that is represented in the source content and false if the text represents an entity that is not represented in the source content (or is not associated with a particular entity)). The priority of the correct entity signal 512 can be about average. In this example, the priority of signals is given a number between 1 and 7 (with one being the highest and seven being the lowest), and the correct entity signal 512 is assigned a 3. The chip 530-5 displayed in the user interface to notify the user that a particular entity is correct may be one of “Date in source,” “Number in source,” “Location in source,” “Person in source,” or “Organization in source.”

The not grounded signal 514 can be defined (as in the definition of the signal 530-1) as representing whether a particular portion of the outline is based on the source document. The not grounded signal 514 can be used to identify information in the outline that may not be based on the source content and should be removed or altered. The length (e.g., column 530-2) of text for which a not-grounded signal can be generated is up to a sentence. The not grounded signal 514 can be binary (e.g., set to true if the text is not based on the source content and false if the text is based on the source content the source content (or is not associated with a particular entity)). The priority of the not grounded signal 514 can be below average. In this example, the priority of signals is given a number between 1 and 7 (with one being the highest and seven being the lowest), and the not grounded signal 514 is assigned a 4. The chip 530-5 displayed in the user interface to notify the user that a particular portion of text is not grounded may be “Not based on source.”

The grounded signal 516 can be defined (as in the definition of the signal 530-1) as representing whether a particular portion of the outline is based on the source document. The grounded signal 516 can confirm that the information in the outline based on the source content should be removed or altered. The length (e.g., column 530-2) of text for which a grounded signal 516 can be generated is up to a sentence. The ground signal 516 can be binary (e.g., set to true if the text is based on the source content and false if the text is not based on the source content the source content (or is not associated with a particular entity)). The priority of the grounded signal 514 can be very low. In this example, the priority of signals is given a number between 1 and 7 (with one being the highest and seven being the lowest), and the grounded signal 514 is assigned a 7. The chip 530-5 displayed in the user interface to notify the user that a particular portion of text is likely grounded may be “Based on Source.”

In some examples, the document generation system can use the priority to determine which signals should be presented to the user (using visual indicators such as highlighting or underlining). Each signal can have a distinct color or format, and the interface can include a legend that describes the signals. In some examples, the colors may be determined based on the severity of the signal it represents, so negative signals may be coded red, positive signals may be coded green, and the brightness represents the degree to which the system is confident in the signal. Other methods (or color combinations) can be used for visual indicators. If a portion of text has more than one positive signal, the content generation system can select the signal with the highest priority and only use the visual indicator for that signal in the user interface.

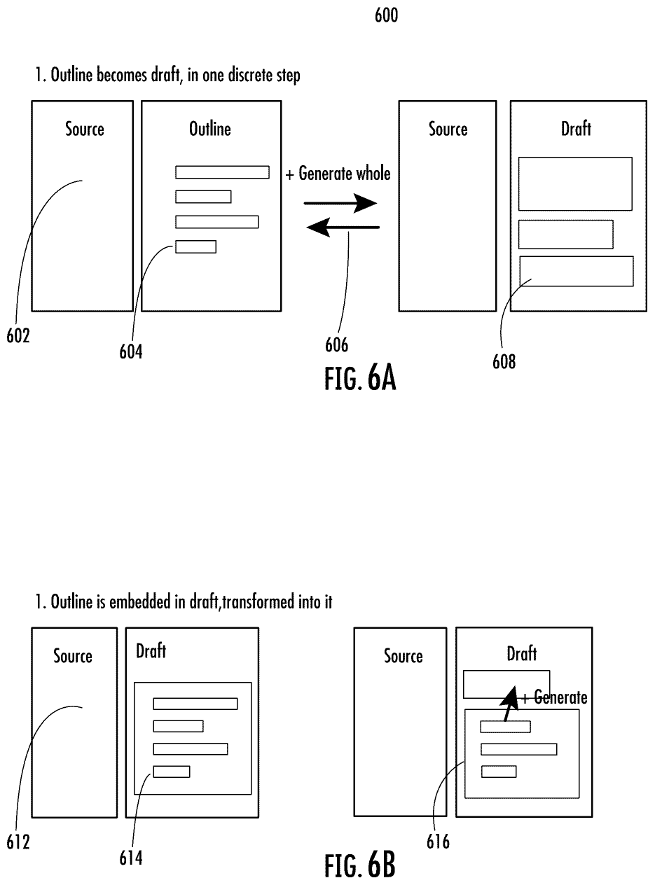

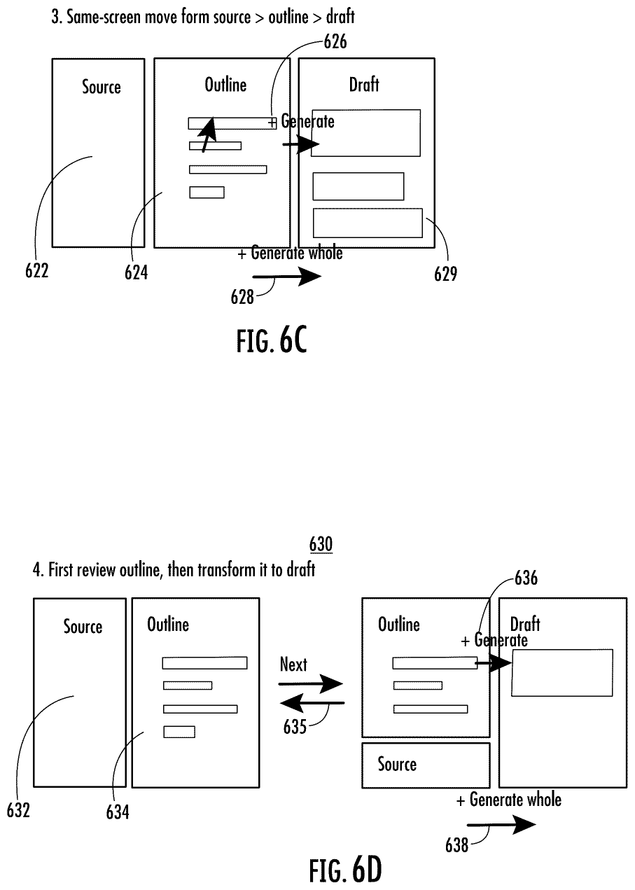

FIG. 6A illustrates an example of the user interface flow 600 when converting an outline of a document to a completed draft of that document in accordance with the example embodiments. In this example, the interface initially displays the source document 602 and the outline 604 side by side. Once the user has made any edits and approved the outline, the user can select the “generate” option.

In response, the document generation system can generate, at 606, a complete draft 608 based on the outline. The source document 602 may still be displayed to the user. The user interface can be updated to include the source document and the fully generated draft 608. In some examples, the user can also revert to the outline view.

FIG. 6B is an illustrative example of a user interface flow 610 when converting an outline of a document to a completed draft of that document in accordance with the example embodiments. In this example, the source document 612 and the draft of the outline 614 are displayed simultaneously, side by side. The user can edit the outline by reviewing a plurality of displayed nodes (e.g., wherein one or more nodes represent a section of the draft). As the user completes edits to each node, the user can choose to convert only that portion of the outline into a final draft, see 616. In this way, the user interface does not need to transition between the outline and draft views. Instead, the outline is converted, piece by piece, into the full draft, all within the same interface.

FIG. 6C is an illustrative example of a user interface flow 620 when converting an outline of a document to a completed draft of that document in accordance with an example embodiments of the present disclosure. In this example, the source content 622 and the outline 624 are displayed side by side on a particular user interface. In this example, the outline can be converted piecemeal (e.g., node by node), at 626, or transformed all at once, at 628. In either case, the user interface is updated to change the text of the outline for the text of the full draft 629.

FIG. 6D is an illustrative example of a user interface flow 630 when converting an outline of a document to a completed draft of that document in accordance with an example embodiment. In another example, the source document 632 and outline 634 can be initially displayed together. However, when the user is ready to begin converting, at 635, the outline to the entire draft, the user interface can be updated to display the outline and the draft portions that have already been completed if it is being converted node by node, at 636, or the whole draft if it is being converted all at once at 638.

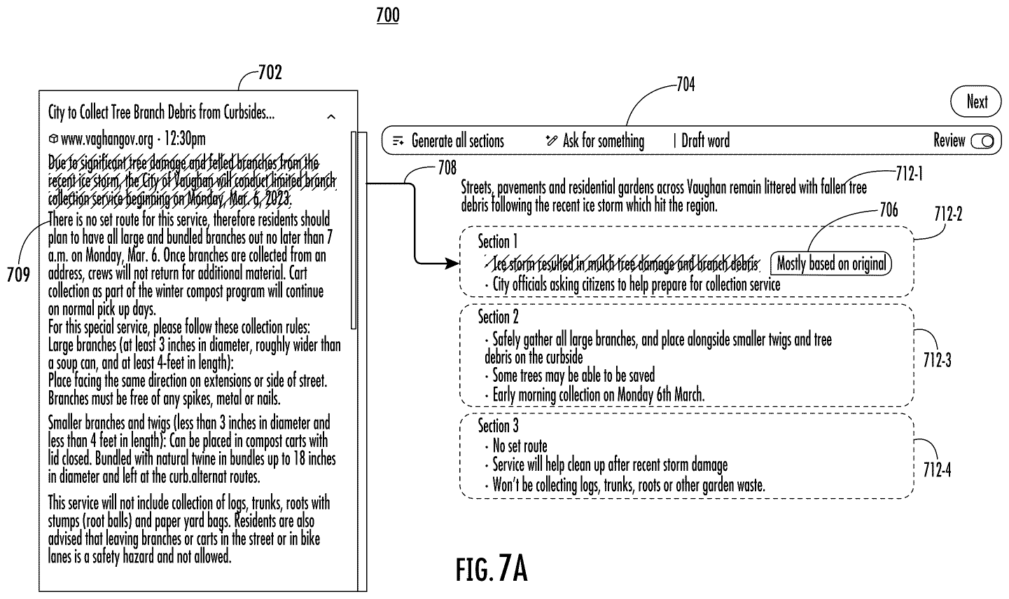

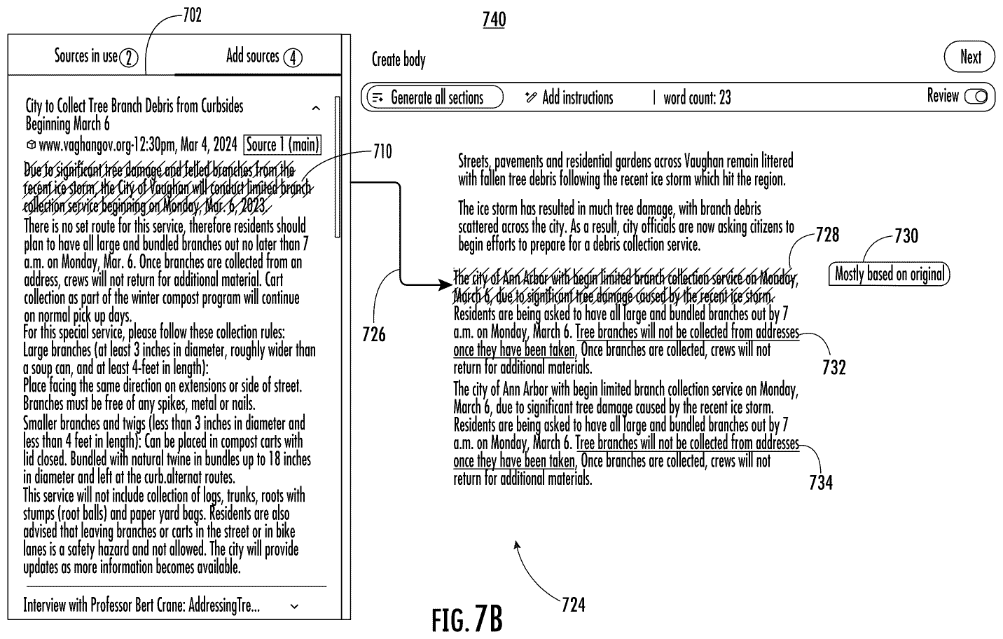

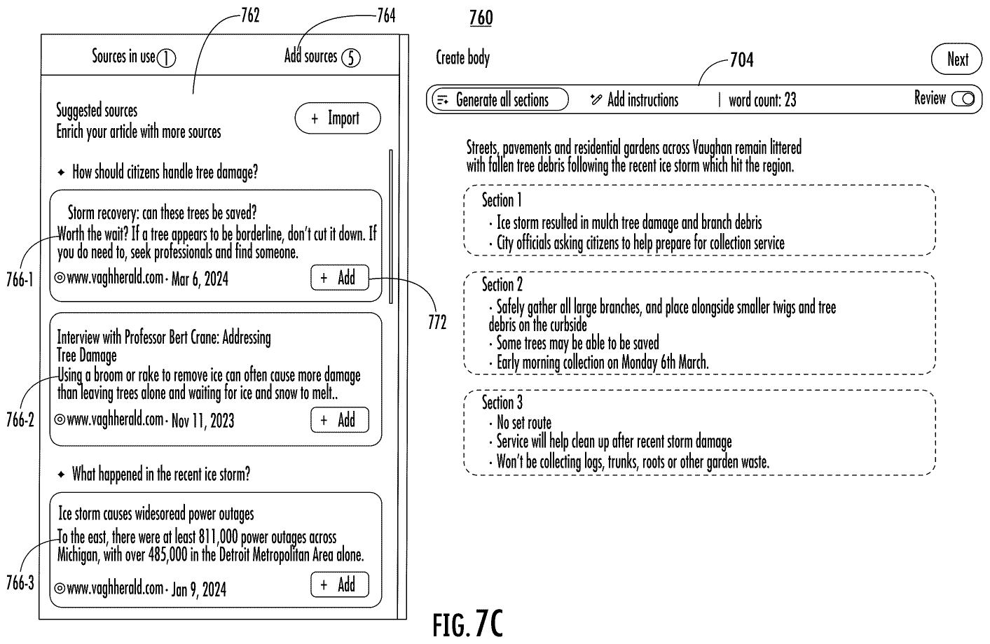

FIG. 7A illustrates an example user interface for presenting an outline to the user for revisions before generating the complete draft in accordance with example embodiments of the present disclosure. In this example, the user interface includes the original version of the source content 702 and a draft of an outline 704. As can be seen, the source content 702 and the draft of the outline 704 are displayed side by side.

In some examples, the draft outline 704 can include a plurality of nodes. Each node (e.g., nodes 712-1 to 712-5) can represent a section of the draft. In this example, the outline includes a node for the lede 712-1 and a plurality of nodes for a plurality of paragraphs (e.g., 712-2 to 712-5) within the article. The lede node 712-1 includes a short description of the article's content, and the paragraph nodes (e.g., nodes 712-1 to 712-5) can represent the content intended to be included in each paragraph. Each note can have one or more bullet points indicating the facts to be covered in that paragraph.

In some examples, the draft outline 704 includes visual indicia of various signals that are important for generating a complete draft of the article. For example, some portions of the outline are underlined or highlighted. Each particular signal represents a piece of information that the user may be reviewing the article. For example, for particular factual data, the document generation system can update the user interface to display indications indicating which portion of the source data a particular fact came from and a representation of whether that fact is well-supported. In this example, a particular node 712-2 includes visual indicia, which notes that the particular fact is likely based on the original document (e.g., it has a high value for the highly supported signal). In some examples, the interface can also include a note explaining the visual indicia to the user. In this example, the note reads, “Likely based on an original.”

The user interface also includes one or more arrows or lines connecting the node 706 (e.g., node 706, which indicates the bridge collapsed at 1:00 AM) with good support to a portion (e.g., the highlighted sentence 710) of the original document 702 from which the content of node 706 is sourced. An arrow 708 can connect the two portions. Portions of the text with less well-supported information can be highlighted differently.

Highlighting the content of the outline based on one or more signals that are associated with the outline can aid the user in efficiently and effectively reviewing the outline content. Updating the user interface to include visual indicators representing any signals with values that satisfy a threshold can allow the user to determine whether changes or adjustments need to be made effectively.

FIG. 7B illustrates an example user interface for presenting a full draft to the user for revisions before generating the complete draft in accordance with example embodiments of the present disclosure. In this example, the user interface includes the original version of the source content 702 and a fully generated draft 724 of a document. As can be seen, the source content 702 and the fully generated draft 724 are displayed side by side.

The content generation system can use a machine-learned system to analyze the fully generated draft seven to four. The machine-learned system can generate a priority of signals for the text. Each signal can give a portion of text a score. Each signal score can have a predetermined threshold. Suppose the score for a particular portion of text is above the threshold. In that case, the system can determine that the characteristic associated with the signal is present in the portion of text. For example, the signals can be associated with positive characteristics of the text (e.g., it is well supported, it includes known entities, it accurately quotes the source, and so on) or negative characteristics of the text (it includes mistakes, it includes incorrect quotes, includes information without a basis in the source, it has sensitive of material, and so on).

The user interface can be updated to include indicia of one or more signals with scores exceeding a threshold. For example, a portion of text 728 can be determined to be supported and based on the information in the source document. The indicia can include highlighting and or underlining. In addition, some signals can have an associated message that alerts the user about the visual indicators. In this example, the portion of text 728 has an associated message 730. The message 730 reads, “Mostly based on original.”

This example portion of text 728 may have a high score for grounding in the original text. In some examples, the visual indication can include an arrow or line 726 that connects the highlighted portion of text 728 to portion 710 of the source document 702 from which the information was received.

In some examples, the visual indicia (e.g., see 732 and 734) may not have explanatory text to describe the specific issue. In other examples, the user can see the explanatory text if the user selects (e.g., clicks on or otherwise interacts with) the text with the visual indicia.

FIG. 7C illustrates an example user interface 760 for adding additional references for an outline in accordance with example embodiments of the present disclosure. In this example, the user interface 760 includes a display of a plurality of potential additional sources 762 and a draft outline 724 of a document. As can be seen, the plurality of potential additional sources 762 and the draft outline 724 of the document are displayed side by side.

In some examples, when the user submits a content source for use in generating the document, the content generation system can, using a recommendation system, determine the discussed in the source content and generate a list of potentially useful additional sources. The user interface can have an add sources tab 764. If the user selects the add sources tab, as in this example, the user interface will update to display a list of suggested sources 762.

The list of suggested sources can include a plurality of sources (e.g., 766-1, 766-2, and 766-3). The list of suggested sources 762 can display, for each source, a brief indication of the content of the source comma and an interface button (e.g., button 772) that will allow that source this content to be added to the outline.

In some examples, the additional sources can be documents that are publicly available to the machine-learned model (and everyone else) over the Internet. In some examples, the extra sources (e.g., peripheral sources) can add relevant information to the document but are less newsworthy than the source content. There can be many additional sources for any one piece of source content. In some examples, only a few facts from each additional source may be used in the draft outline or final document (e.g., sometimes only one fact). The content generation system may not identify any additional sources. In some examples, users can submit additional sources so that the generated outline is based on more than one source submitted by the user.

In some examples, once the user has added an additional resource to the outline, the generative model can update the outline to include an additional section associated with the newly added source. In some examples, the system can add more than one section to the outline based on the content in the newly added one or more sources. The users can make edits to the added sections and slash or change the order in which the sections are listed in the outline so that the additional information from the newly added sources fits better into the flow of the document to be generated. Once the user approves the outline, the content generation system can generate the drafted document.

In some examples, the content generation system can generate one or more citations for a plurality of portions of the fully generated draft. In this way, once the draft has been generated, the user can determine the source of each portion of the full draft. The citations can be included in a related document or incorporated into the document itself. In some examples, the citations can include a link to the document from which the information was accessed. In this way, a user can confirm the details and content of the draft document.

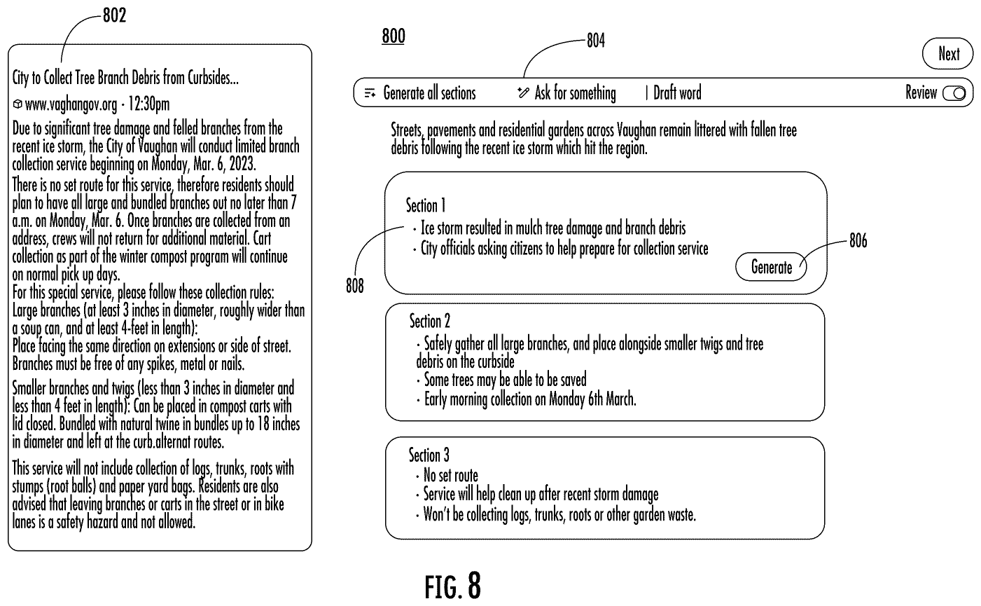

FIG. 8 illustrates an example user interface for presenting an outline in a user interface to allow for user revisions before generating the complete draft in accordance with the example embodiments of the present disclosure. In this example, the user interface displays a source document 802 and a draft outline 804. The user interface can display a lede and a plurality of nodes for a plurality of proposed paragraphs. The user can edit the nodes (e.g., rearranging the nodes, adding or removing text, and so on) as desired based on the information provided by the document generation system through visual indicators.

Once the user is satisfied with the outline, the user interface can enable the user to generate a complete draft of the document based on the outline 804. In some examples, the user can choose to generate the entire draft at once using a “Generate everything” interface element. In other examples, the user can choose to generate the complete draft on a node-by-node basis. In this way, a user can generate each portion of the article order and reference the already generated portions of the article when reviewing later nodes.

For example, the first paragraph node 808 can include a user interface element. This user interface element is a button 806 with the word “Generate” on it. Thus, when the content of the paragraph or node is acceptable to the user, the user can select the “Generate” button 806, and the specific outline node 808 content will be replaced with generated article content from a generative model.

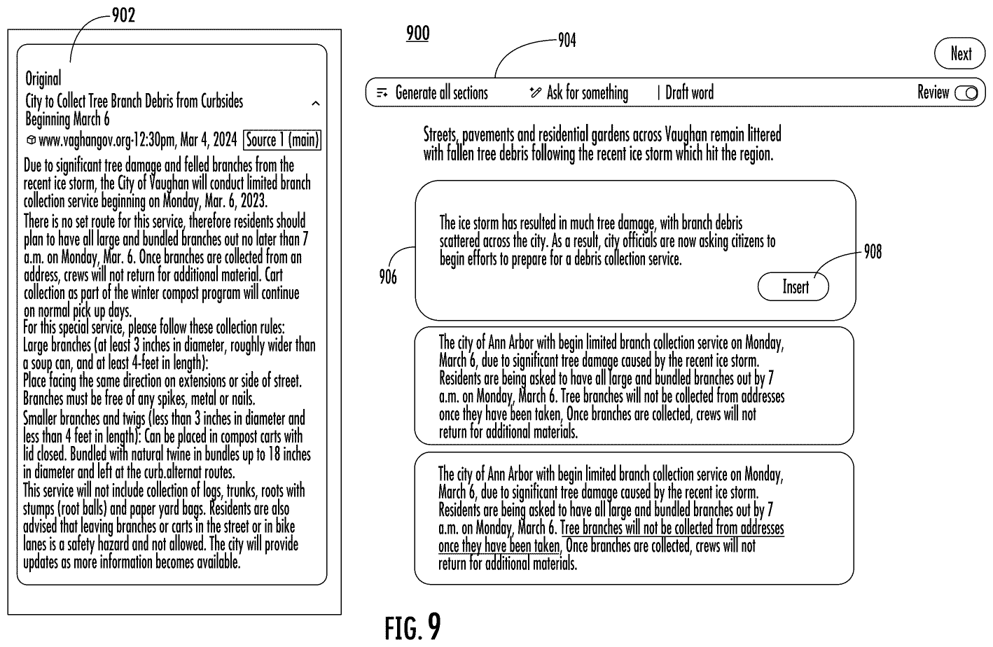

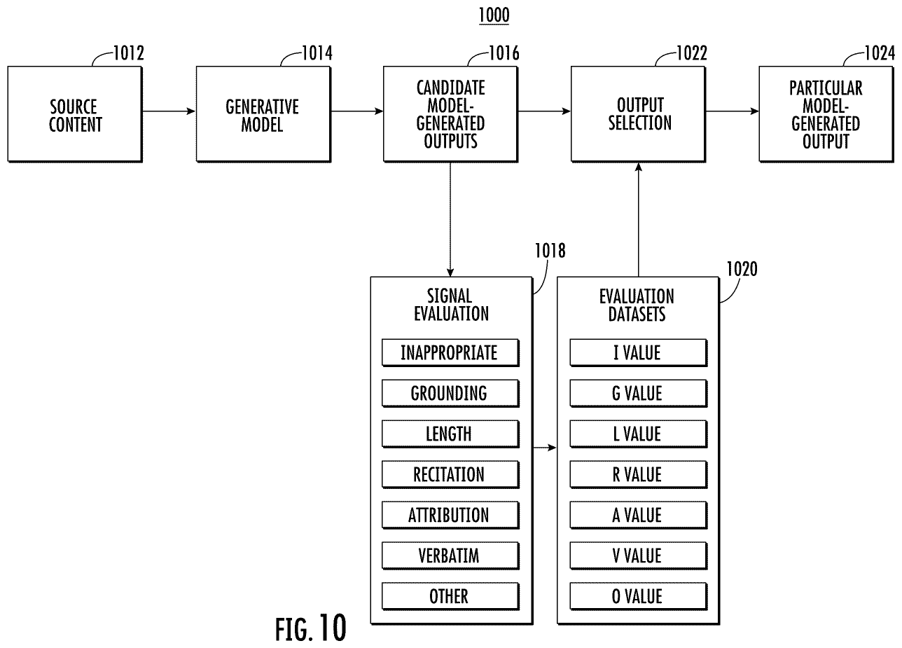

FIG. 9 illustrates an example user interface for presenting an outline to the user for revisions before generating the complete draft in accordance with the example embodiments of the present disclosure. The user interface includes a source document 902 and a draft outline 904 in this example. In this example, the user generates the draft on a node-by-node basis. Specifically, a particular node has been converted into a draft paragraph 906, and the user interface has been updated to include an element to refine paragraph 910 and an element to insert 908 the paragraph into the final draft. The draft paragraph 906 can include natural language, as would be expected in a finished document. This proposed article text can be displayed to the user. The user can make revisions or edits. Once the user is happy with the full version of the draft, they can choose to insert the paragraph into the finished article.

The user interface includes a next button 912, which the user can select to view the article. As each node in the outline is approved and inserted, the finished article will become more complete.

FIG. 10 depicts a block diagram of an example candidate model-generated content item selection system 1000 according to example embodiments of the present disclosure. In particular, the candidate model-generated content item selection system 1000 can process the source content 1012 with one or more generative models 1014 to generate a plurality of candidate model-generated outputs 1016. The plurality of candidate model-generated outputs 1016 can then be processed to perform signal evaluation 1018 for the plurality of candidate model-generated outputs 1016 to generate a plurality of respective evaluation datasets 1020. The plurality of respective evaluation datasets 1020 can then be utilized for output selection 1522 to select a particular model-generated output 1524 to provide to the user computing system.

For example, the candidate model-generated content item selection system 1000 can obtain source content 1012. The source content 1012 can include a set of details to be leveraged to generate a longform domain-specific content item. The source content 1012 can include a press release, interviews, experimental data, a set of news articles, a fact pattern, and/or other source information.

The source content 1012 can be processed to select one or more particular generative models 1014 to utilize. For example, the source content 1012 can be processed to determine one or more tasks associated with the source content 1012. One or more particular generative models 1014 of a plurality of candidate generative models may be determined based on the one or more tasks. The plurality of candidate generative models can include a plurality of domain-specific generative models that may perform differently on different tasks. In particular, the plurality of candidate generative models may have different configurations, different training datasets, different tuning datasets, and/or different sizes.

The one or more generative models 1014 can process the source content 1012 to generate a plurality of candidate model-generated outputs 1016 (e.g., a plurality of candidate model-generated content items). The plurality of candidate model-generated outputs 1016 (e.g., a plurality of draft domain-specific content items) can include a plurality of model-generated news articles, a plurality of model-generated research papers, a plurality of model-generated newsletters, a plurality of model-generated emails, and/or a plurality of other domain-specific model-generated content items.

The plurality of candidate model-generated outputs 1016 can then be evaluated via signal evaluation 1018. For example, each of the plurality of candidate model-generated outputs 1016 can be evaluated for inappropriateness, factual grounding, length, recitation, attribution, verbatim, and/or other quality signals. The inappropriateness can be associated with profanity, sensitive topics, pornography, private information, legality, gore, and/or other appropriateness factors. The factual grounding can be determined based on whether facts in the candidate model-generated outputs 1016 have factual grounding in the source content 1012 and/or other factual resources. The length can be determined based on a range associated with the particular domain. The recitation can be determined based on quotes and/or other direct recitations are accurately recited. The attribution can be based on the accuracy and/or appropriateness of attributions (e.g., quote attributions, resource citations, etc.). The verbatim can be determined based on a determined level of verbatim inclusion of content. For example, a likelihood of plagiarism may be determined.

The signal evaluation 1018 can be performed to generate a plurality of evaluation datasets 1020. Each of the plurality of evaluation datasets 1020 can include a plurality of signal values associated with a respective candidate model-generated output. Each evaluation dataset 1020 can include an inappropriateness value, a factual grounding value, a length value, a recitation value, an attribution value, a verbatim value, and/or other quality signal values.

The plurality of evaluation datasets 1020 can then be processed to perform output selection 1022. The output selection 1022 can include filtering and/or ranking. For example, the candidate model-generated outputs may be filtered to filter out candidate model-generated outputs that do not meet one or more thresholds (e.g., each value may have a threshold value). In some implementations, the output selection 1022 may include ranking the plurality of candidate model-generated outputs 1016 based on the plurality of respective evaluation datasets 1020.

The output selection 1022 can be performed to determine a particular model-generated output 1024 to provide to the user computing system as output. Alternatively and/or additionally, the particular model-generated output 1024 may be processed to generate a model-generated outline that may then be provided to the user computing system.

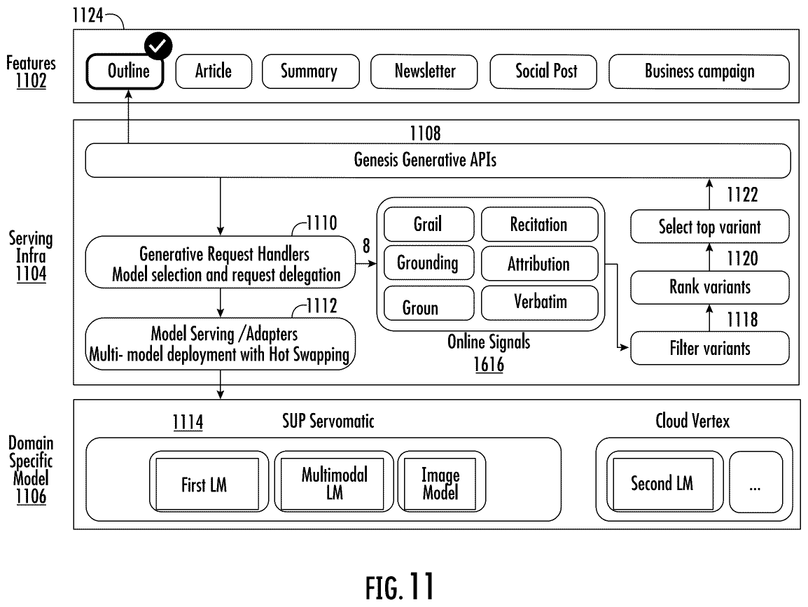

FIG. 11 depicts a block diagram of an example infrastructure system 1100 according to example embodiments of the present disclosure. The infrastructure system 1100 can process source content to select one or more domain-specific generative models 1106, which can then be utilized to process the source content to generate a plurality of candidate model-generated outputs (e.g., model-generated content items and/or model-generated outlines) that may then be evaluated to select a particular model-generated output to provide to the user.

In particular, the infrastructure system 1100 can include features 1102 for generating outlines 1124, articles, summaries, newsletters, social posts, business campaigns, and/or other content items. The infrastructure system 1100 can include a serving infrastructure 1104 for handling the input data obtainment, processing, output generation, output selection, and/or output transmission. The infrastructure system 1600 can include a plurality of different domain-specific models 1606 that may be utilized for content generation.

For example, the serving infrastructure 1104 can leverage a generative application programming interface 1108 to obtain input data and facilitate the output generation and/or processing. In particular, the generative application programming interface 1108 can instruct a generative request handler 1110 to have a model-serving/adapter 1112 interface with one or more domain specific models 1106, which may include a server stored model 1114 and/or a cloud stored model. The one or more particular domain-specific models 1106 may be selected for the content generation. The one or more domain specific models 1106 can include a first language model, a second language model, a multimodal language model, and/or an image generation model. The one or more particular domain-specific models 1106 can process the source content to generate a plurality of candidate model-generated outputs. The generation may be limited to a certain number of candidate model-generated outputs (e.g., eight).

The generative request handler 1110 may facilitate the evaluation of the plurality of candidate model-generated outputs based on a plurality of signals 1116. The plurality of signals 1116 can include a plurality of online signals, which may include an inappropriateness signal, a grounding signal, a length signal, a recitation signal, an attribution signal, a verbatim signal, and/or other signals. The plurality of candidate model-generated outputs (and/or variants) may then be filtered 1618 to filter out candidates that do not meet one or more signal thresholds. The remaining candidate model-generated outputs may then be ranked based on the plurality of signals 1116 to select 1122 a particular candidate model-generated output (e.g., a top variant).

The generative application programming interface 1108 may then transmit the particular candidate model-generated output (e.g., a top variant) to the user computing system for display.

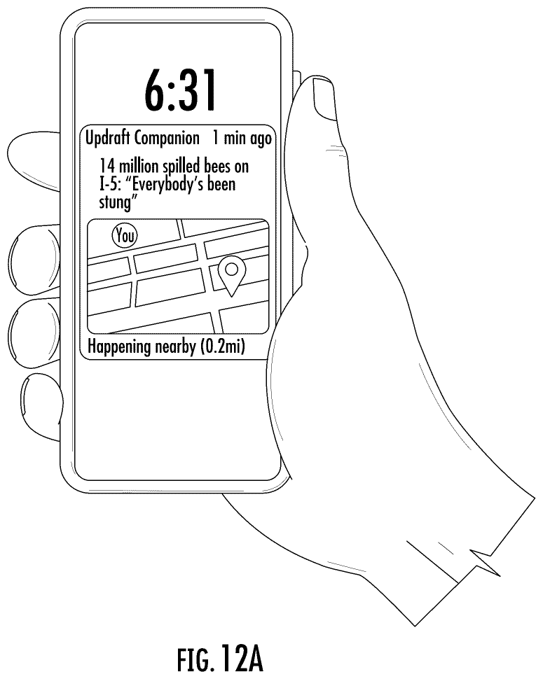

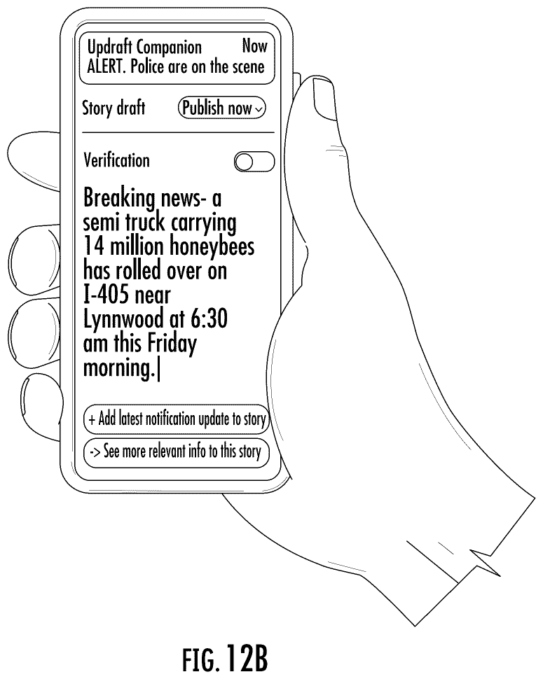

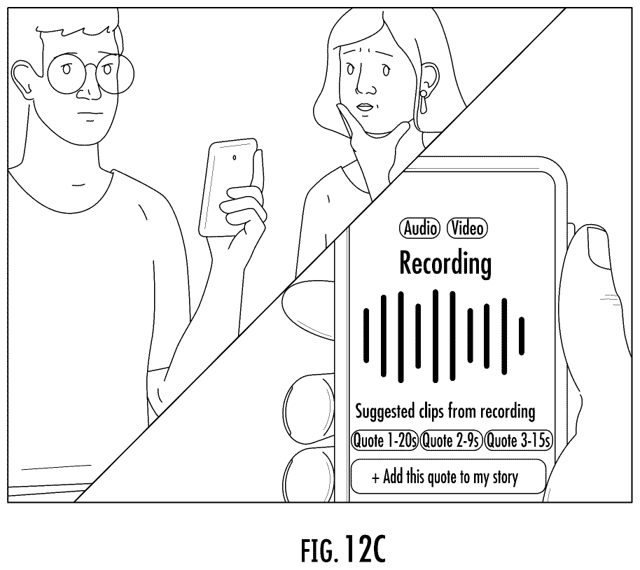

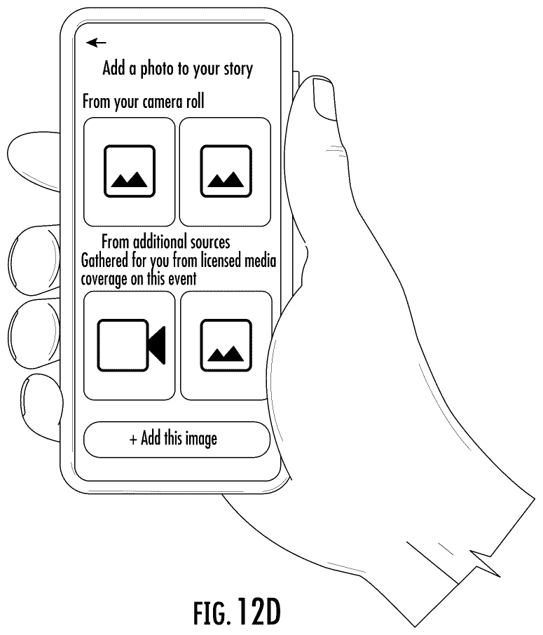

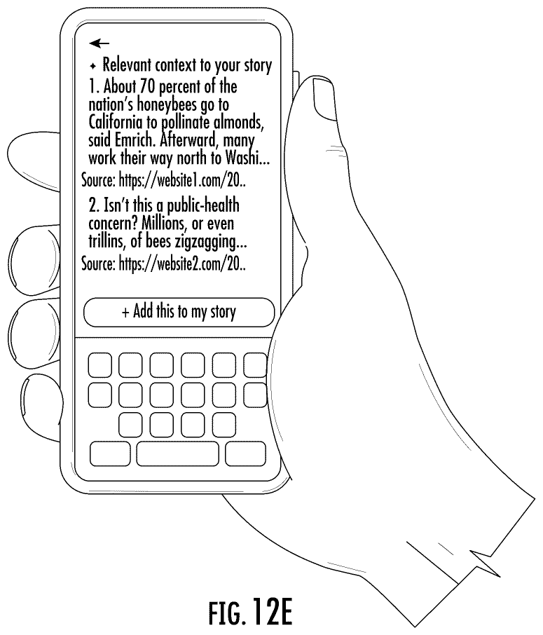

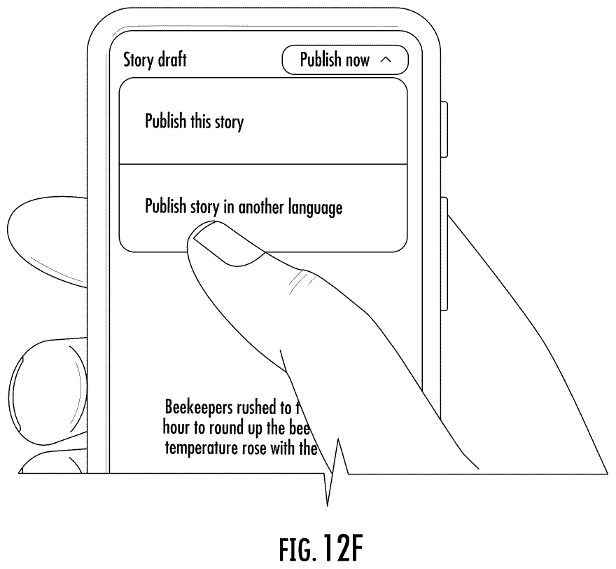

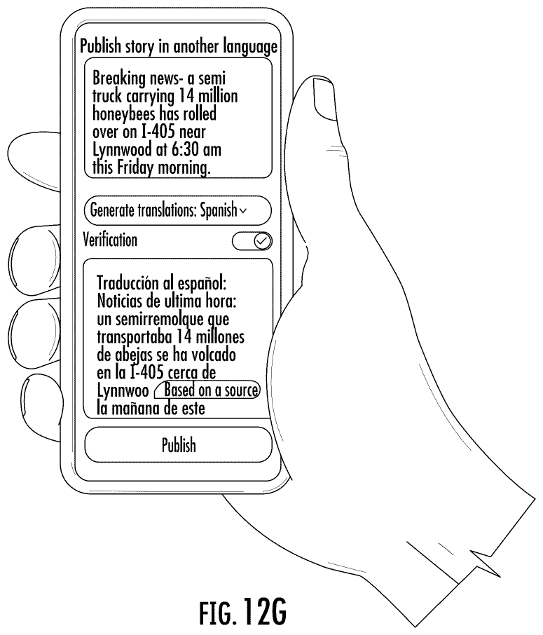

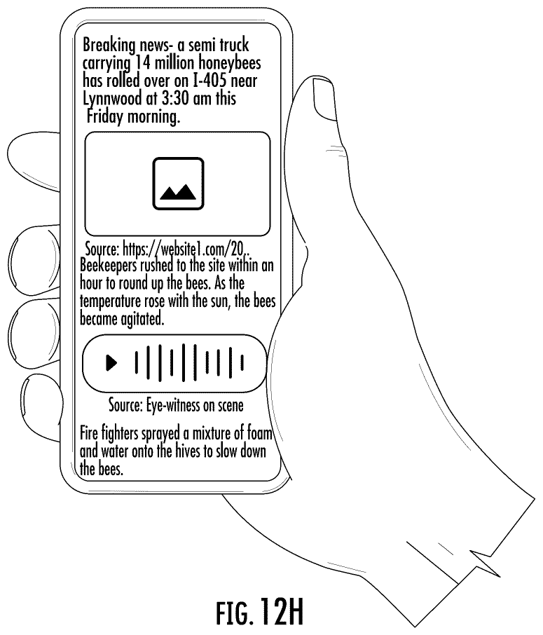

FIGS. 12A-12H depicts illustrations of an example content generation interface according to example embodiments of the present disclosure. In particular, the content generation interface can be provided at a user computing device, which may include a desktop computer, a personal computer, a mobile computing device, a smart wearable, and/or other computing device.

At 1202 of FIG. 12A, a mobile-first scenario can be provided for display. A journalist can use a content generation interface (e.g., an updraft companion) to track breaking news and report on a story while out in the field. The content generation interface can monitor public safety channels and other sources in the background to gather signals on potential new stories. When the content generation interface identifies a developing story, the content generation interface can trigger an alert.

At 1204 of FIG. 12B, after a user taps on an alert, the journalist can respond quickly to draft a breaking news story with the domain-specific generative model. The tap can initiate the source content being transmitted to the domain-specific generative model to generate one or more model-generated content items (e.g., one or more news articles (e.g., one or more stories)).

At 1206 of FIG. 12C, the journalist can arrive on the scene and can interview an eyewitness. The content generation interface can transcribe the recording and can summarize the interview with suggested “pull quotes” to add to the story. The transcribed interview and/or the summary may be provided with the news alert information to the domain-specific generative model to act as source content for generating the model-generated content item.

At 1208 of FIG. 12D, the journalist can take photos on the scene, can use the content generation interface to save the photos, can crop the one or more photos, and can organize the photos. The content generation interface can scan social media (e.g., the social media of the user and/or a user's image gallery) for additional imagery. The images may be obtained based on an embedding search, a label search, and/or a keyword search.

At 1210 of FIG. 12E, the content generation interface can search web sources in the background for additional contextually relevant information. The contextually relevant information can include “This is the 2nd truck accident at the same location this month,” and/or “There are economic and environmental implications to the loss of pollinators.” The contextually relevant information may be obtained from one or more trusted web resources.

At 1212 of FIG. 12F, the journalist can tap Publish, and can see the option to publish the story as is, and may be given the option to translate the model-generated content item to another language. Additionally and/or alternatively, the user (i.e., the journalist) can be provided with options to edit (and/or update) the model-generated content item.

At 1214 of FIG. 12G, the journalist can choose to publish a Spanish version of the story (i.e., the model-generated content item), to serve a community's Spanish-speaking population. Additionally and/or alternatively, the content generation interface can enable the journalist to assess the quality of the translation and can verify that the story is still “grounded” in reliable sources.

At 1216 of FIG. 12H, the story (i.e., the model-generated content item) story can be ready to go, and the journalist can publish the story directly from their mobile device to web/email/social media.

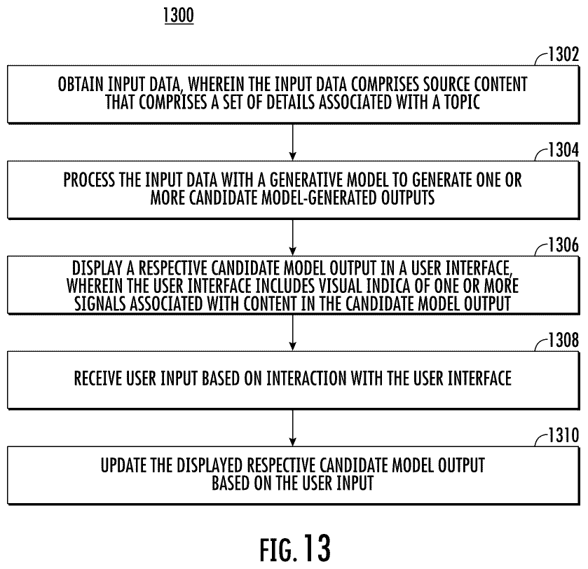

FIG. 13 depicts a flow chart diagram of an example method to perform according to example embodiments of the present disclosure. Although FIG. 13 depicts steps performed in a particular order for purposes of illustration and discussion, the methods of the present disclosure are not limited to the particularly illustrated order or arrangement. The various steps of the method 1300 can be omitted, rearranged, combined, and/or adapted in various ways without deviating from the scope of the present disclosure.

At 1302, a computing system can obtain input data. The input data can include source content that includes a set of details associated with a topic. The input data may include a soft prompt associated with the particular user. The soft prompt may include a plurality of parameters and/or weights tuned to emulate the style of writing of the particular user. The source content may include a press release, interviews, a box score of a sporting event, an email, and/or other sources. The set of details may include a set of facts, a direction for a story, and/or other details.

At 1304, the computing system can process the input data with a generative model to generate a plurality of candidate model-generated outputs. The plurality of candidate model-generated outputs may include a plurality of candidate model-generated news article drafts. The plurality of candidate model-generated outputs (e.g., the plurality of candidate model-generated news article drafts) can be generated based on the source content. In some implementations, the generative model may have been tuned on a domain-specific training dataset associated with a particular field of expertise. For example, the generative model may have been tuned using a domain-specific training dataset that includes a plurality of news articles. The plurality of news articles can include a particular information structure and a particular set of publication type-specific stylistic characteristics. The generative model may include a domain-specific generative model. The domain-specific generative model may include a pre-trained generative language model that was tuned on a domain-specific training dataset to generate predicted content items that include one or more domain-specific attributes.

In some implementations, the domain-specific training dataset can include a plurality of content items of a particular publication type. The particular publication type can include a news article type, a research paper type, a newsletter type, an email type, and/or other publication type. The plurality of content items of the particular publication type can include a particular information structure and a particular set of publication type-specific stylistic characteristics. The particular information structure can include an inverted pyramid structure for news article types. For example, the news article can begin with the who, what, when, where, why, and how of the story (e.g., the most newsworthy information). The news article can then include important details that provide additional key details associated with the who, what, when, where, why, and how of the story. Other lesser details can then be included after the additional key details. The particular information structure for scientific research papers can include a high-level abstract then an introduction, then related works, then a discussion of the discovery including the researcher's method, then experimental data, and then a conclusion. The particular information structure for a newsletter can include a title, a greeting, an introduction, and a list of pertinent topics.

In some implementations, the particular set of publication type-specific stylistic characteristics can include the tone (e.g., a factual tone for news article), particular publication type-specific stylistic name or term use (e.g., news articles write out the full name of a person upon first instance, news articles may limit slang to quotes, and/or news articles may use particular term for a certain occupation, pace, or thing), particular lengths (e.g., news articles may have relatively short sentences and paragraphs, when compared to a literary review of an artistic work), publication type-specific citations (e.g., attribution in news articles can follow different citation style requirements than academic papers or law briefs), and/or other publication type-specific stylistic characteristics.

At 1306, the computing system can display a respective candidate model output in a user interface, wherein the user interface includes visual indicia of one or more signals associated with content in the candidate model output. The plurality of signals may be associated with appropriateness of the content, factual grounding, length, correct recitation of quotes and/or facts, proper attribution to the one or more sources, a level of verbatim word and/or phrase usage, and/or other quality signals. Evaluating the plurality of candidate model-generated outputs may include processing the source content and the plurality of candidate model-generated outputs with one or more machine-learned models. The one or more machine-learned models may include the generative model.

At 1308, the computing system can receive augmentation input based on interaction with the user interface. In some examples, the augmentation input can be provided using the user interface. Augmentation input can include edits to text, updating or changing the order of information presented in the candidate model output, adding additional information, and so on.

At 1310, the computing system can update the displayed respective candidate model output based on the augmentation input. In some implementations, the computing system can process the input data to determine one or more particular generative models of a plurality of candidate generative models to process the source content with to generate the plurality of candidate model-generated outputs. The generative model can include the one or more particular generative models. The plurality of candidate generative models can include one or more generative language models and one or more image generation models.

In some implementations, processing the input data to determine the one or more particular generative models of a plurality of candidate generative models can include determining a particular task associated with the input data and determining the one or more particular generative models of a plurality of candidate generative models are associated with the particular task. In some implementations, the computing system can process the augmented outline with the generative model to generate an updated model-generated output. The updated model-generated output can include an updated model-generated news article. The computing system can provide the updated model-generated output for display. The augmentation input can adjust the structure and one or more topic points of the outline of the particular candidate model-generated output. In some implementations, the updated model-generated output and the particular candidate model-generated output can include different structures. The updated model-generated output can include one or more additional sections associated with one or more additional topic points compared to the particular candidate model-generated output.

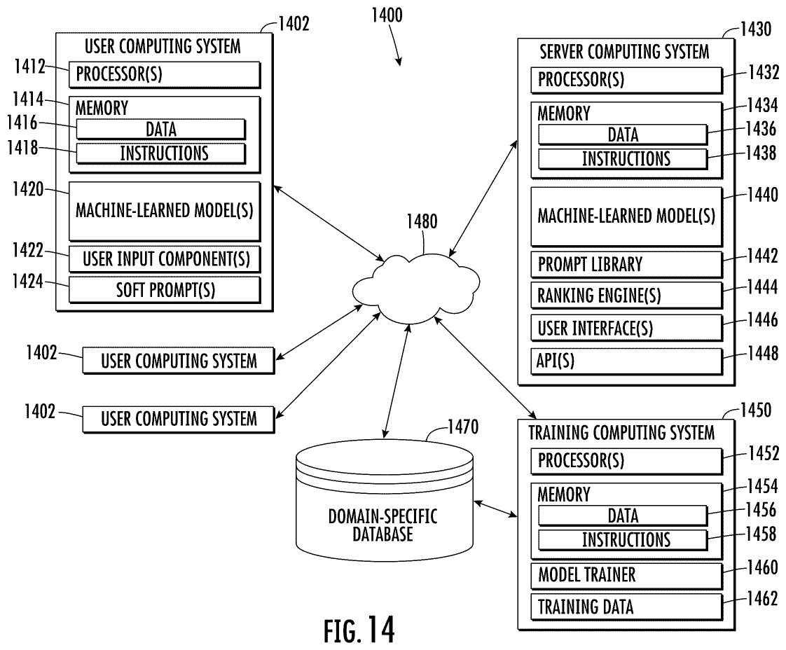

FIG. 14 depicts a block diagram of an example computing system 1400 that performs domain-specific content item generation according to example embodiments of the present disclosure. The system 1400 includes a user computing system 1402, a server computing system 1430, and a training computing system 1450 that are communicatively coupled over a network 1480. The system 1400 can include iterative communications between the user computing system 1402, the server computing system 1430, and/or the training computing system 1450. For example, the user computing system 1402 and the server computing system 1430 may exchange transmissions upon each instance of content generation. Alternatively and/or additionally, the user computing system 1402, the server computing system 1430, and/or the training computing system 1450 may be utilized to train one or more machine-learned models 1420 and/or one or more soft prompts 1424 that may then be transmitted and/or stored on the user computing system 1402 for off server (and/or offline) content generation.

The user computing system 1402 can include any type of computing device, such as, for example, a personal computing device (e.g., laptop or desktop), a mobile computing device (e.g., smartphone or tablet), a gaming console or controller, a wearable computing device, an embedded computing device, an edge computing device, and/or any other type of computing device.

The user computing system 1402 includes one or more processors 1412 and a memory 1414. The one or more processors 1412 can be any suitable processing device (e.g., a processor core, a microprocessor, an ASIC, a FPGA, a controller, a microcontroller, etc.) and can be one processor or a plurality of processors that are operatively connected. The memory 1414 can include one or more non-transitory computer-readable storage mediums, such as RAM, ROM, EEPROM, EPROM, flash memory devices, magnetic disks, etc., and combinations thereof. The memory 1414 can store data 1416 and instructions 1418 which are executed by the processor 1412 to cause the user computing system 1402 to perform operations.

In some implementations, the user computing system 1402 can store or include one or more machine-learned models 1420 (e.g., machine-learned generative models). For example, the machine-learned models 1420 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks, and/or other forms of neural networks. The one or more machine-learned models 1420 can include one or more feed-forward models, one or more recurrent models, one or more convolutional models, one or more self-attention models, one or more transformer models, and/or one or more other models. The one or more machine-learned models can include different layers, blocks, sub-models, and/or models in one or more configurations, which can include parallel processing, processing in series, bypass processing, recurrent processing, and/or a mixture of approaches. The one or more machine-learned models 1420 can include pre-trained generative models that are then tuned based on a domain-specific training dataset. The one or more generative models may include one or more transformer models. In some implementations, the one or more generative models can include a large language model (e.g., a foundational model, a vision language model, etc.), an image generation model (e.g., a text-to-image model, an audio generation model, and/or one or more other data generation models. The one or more generative models may include an autoregressive language model and/or a diffusion model. Example machine-learned models 1420 are discussed with reference to FIGS. 1-4, 7-10, 15-16, & 18-20.

In some implementations, the one or more machine-learned models 1420 can be received from the server computing system 1430 over network 1480, stored in the user computing device memory 1414, and then used or otherwise implemented by the one or more processors 1412. In some implementations, the user computing system 1402 can implement multiple parallel instances of a single machine-learned model 1420 (e.g., to perform parallel domain-specific content item generation across multiple instances of input/obtained source content).

More particularly, the machine-learned model 1420 can be trained and/or tuned for domain-specific content generation (e.g., a domain-specific generative model). The domain-specific content generation model can process input data to generate one or more domain-specific model-generated content items. The input data can include source content that can provide details (e.g., facts and/or a theme) that can be leveraged by the generative model to generate the one or more domain-specific model-generated content items. The domain may include news articles, research papers, newsletters, and/or another field of expertise. For example, a pre-trained generative model may be tuned to generate news articles based on press releases (e.g., the source content may be the press release and the domain-specific model-generated content item may be a model-generated news article).

Additionally or alternatively, one or more machine-learned models 1440 can be included in or otherwise stored and implemented by the server computing system 1430 that communicates with the user computing system 1402 according to a client-server relationship. For example, the machine-learned models 1440 can be implemented by the server computing system 1430 as a portion of a web service (e.g., a domain-specific content item generation service). Thus, one or more models 1420 can be stored and implemented at the user computing system 1402 and/or one or more models 1440 can be stored and implemented at the server computing system 1430.

The user computing system 1402 can also include one or more user input component 1422 that receives user input. For example, the user input component 1422 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

In some implementations, the computing system 1400 may utilize one or more soft prompts 1424 for conditioning the one or more machine-learned models (1420 and/or 1440) for downstream tasks. The one or more soft prompts 1424 can include a set of tunable parameters that can be trained (or tuned) as the parameters of the one or more machine-learned models (1420 and/or 1440) are fixed. The one or more soft prompts 1424 can be trained for a specific task and/or a specific set of tasks. Alternatively and/or additionally, the one or more soft prompts 1424 may be trained to condition the one or more machine-learned models (1420 and/or 1440) to perform inferences for a particular individual and/or one or more entities such that the output is tailored for that particular individual and/or particular entities. The one or more soft prompts 1424 can be obtained and processed with one or more inputs by the one or more machine-learned models (1420 and/or 1440).

The one or more soft prompts 1424 can include a set of machine-learned weights. In particular, the one or more soft prompts 1424 can include weights that were trained to condition a generative model to generate model-generated content items that emulate a style, tone, and/or vocabulary of a user and/or a set of users. For example, the one or more soft prompts 1424 can be utilized by a user to generate the style, tone, and/or vocabulary of their manually authored works. The one or more soft prompts 1424 can be extended to a plurality of users. For example, a publisher associated with a publication (e.g., a newspaper) may tune the set of parameters on a plurality of their content items to condition the generative model to generate content items that include their style, tone, and/or vocabulary. The one or more soft prompts 1424 may include a plurality of learned vector representations that may be model-readable.

A particular soft prompt 1424 can be obtained based on a particular user and/or set of users (e.g., members of a particular publishing company (e.g., a newspaper)). The particular soft prompt 1424 can include a set of learned parameters. The set of learned parameters can be processed with the generative model to generate the model-generated content item.

The user computing system 1402 and/or the server computing system 1430 may store one or more soft prompts 1424 associated with the particular user. The soft prompt(s) 1424 can include a set of parameters. The user computing system 1402 and/or the server computing system 1430 may leverage the set of parameters of the soft prompt(s) 1424 and a machine-learned content generation model to generate a model-generated content item. In some implementations, the model-generated content item can be generated based on the set of parameters associated with the particular user.

The utilization of a soft prompt (i.e., a set of parameters that can be processed with a generative model for downstream task conditioning) can reduce the computational cost for parameter tuning for user-specific content generation by reducing the parameters to be tuned. The set of parameters can be limited and may be adjusted while the parameters of the pre-trained generative model stay fixed. The set of parameters of the soft prompt can be utilized to condition the pre-trained generative model (e.g., the machine-learned content generation model) for particular downstream tasks (e.g., content generation that is associated with a style and/or vocabulary of a user).

In some implementations, the generative language model and/or one or more soft prompts 1424 (e.g., a set of machine-learned parameters that can be processed with the input by the generative language model) can be trained to emulate the tone, style, and/or vocabulary of a particular user and/or a set of users to provide content items in terms, tone, styles, and/or dialects that a user traditionally uses.

Machine-learned model(s) 1420 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, and/or other forms of neural networks. Example neural networks can be deep neural networks. Some example machine-learned models can leverage an attention mechanism such as self-attention. For example, some example machine-learned models can include multi-headed self-attention models.

Machine-learned model(s) can include a single or multiple instances of the same model configured to operate on data from input(s). Machine-learned model(s) can include an ensemble of different models that can cooperatively interact to process data from input(s). For example, machine-learned model(s) can employ a mixture-of-experts structure. See, e.g., Zhou et al., Mixture-of-Experts with Expert Choice Routing, arXiv:2202.09368v2 (Oct. 14, 2022).

Input(s) can generally include or otherwise represent various types of data. Input(s) can include one type or many different types of data. Output(s) can be data of the same type(s) or of different types of data as compared to input(s). Output(s) can include one type or many different types of data.

Example data types for input(s) or output(s) include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs or outputs, example combinations of data types include image data and audio data, image data and natural language data, natural language data and software code data, image data and biometric data, sensor data and medical data, etc. It is to be understood that any combination of data types in an input or an output can be present.

An example input can include one or multiple data types, such as the example data types noted above. An example output can include one or multiple data types, such as the example data types noted above. The data type(s) of input can be the same as or different from the data type(s) of output. It is to be understood that the example data types noted above are provided for illustrative purposes only. Data types contemplated within the scope of the present disclosure are not limited to those examples noted above.

The server computing system 1430 includes one or more processors 1432 and a memory 1434. The one or more processors 1432 can be any suitable processing device (e.g., a processor core, a microprocessor, an ASIC, a FPGA, a controller, a microcontroller, etc.) and can be one processor or a plurality of processors that are operatively connected. The memory 1434 can include one or more non-transitory computer-readable storage mediums, such as RAM, ROM, EEPROM, EPROM, flash memory devices, magnetic disks, etc., and combinations thereof. The memory 1434 can store data 1436 and instructions 1438 which are executed by the processor 1432 to cause the server computing system 1430 to perform operations.

In some implementations, the server computing system 1430 includes or is otherwise implemented by one or more server computing devices. In instances in which the server computing system 1430 includes plural server computing devices, such server computing devices can operate according to sequential computing architectures, parallel computing architectures, or some combination thereof.

As described above, the server computing system 1430 can store or otherwise include one or more machine-learned models 1440. For example, the models 1440 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 1440 are discussed with reference to FIGS. 1-4, 7-10, 15-16, & 18-20.

In some implementations, the server computing system 1430 can include a prompt library 1442. The prompt library 1442 can store a plurality of prompt templates (e.g., a plurality of hard prompt templates (e.g., text prompt templates)) and/or a plurality of soft prompts. The plurality of prompt templates can include hard prompt templates (e.g., text string data) that may be combined with the source content to generate a more detailed and complete prompt for the generative model to process. The templates can include text descriptive of the request. The templates may be domain-specific, user-specific, and/or content-specific. The plurality of prompt templates may include few-shot examples.

The prompt library 1442 can store a plurality of soft prompts. The plurality of soft prompts may be associated with a plurality of different domains and/or a plurality of different users. The plurality of soft prompts can include learned parameters and/or learned weights that can be processed with the generative model to condition the generative model to generate content items with particular attributes. The plurality of soft prompts may have been tuned by freezing the parameters of a pre-trained generative model, while the parameters of the soft prompt are learned based on a particular task and/or user. The plurality of soft prompts can include a plurality of different soft prompts associated with a plurality of different users and/or a plurality of different sets of users.

The server computing system 1430 may include one or more ranking engines 1444. The one or more ranking engines 1444 can include one or more functions and/or one or more machine-learned models. The one or more ranking engines 1444 can be configured and/or trained to process a plurality of candidate model-generated content items to generate a ranking of the plurality of candidate model-generated content items based on one or more signals (e.g., a plurality of evaluation signals).

In some implementations, the server computing system 1430 can include one or more user interfaces 1446 that can be utilized to obtain input data and provide output data to the user computing system 1402. The one or more user interfaces 1446 can include graphical user interfaces configured to obtain inputs from a user and provide the outputs for display to the user. The one or more user interfaces 1446 can include a source content input interface, an outline editing interface, a model-generated content item display interface, and/or one or more other interfaces.

Additionally and/or alternatively, the server computing system 1430 may utilize one or more application programming interfaces (API) 1448. The application programming interfaces can facilitate input retrieval, generative model interfacing, ranking engine transmissions, and/or other tasks. The application programming interfaces (API) 1448 can facilitate the exchange of information between applications, models, computing systems, and/or platforms.

The user computing system 1402 and/or the server computing system 1430 can train the models 1420 and/or 1440 via interaction with the training computing system 1450 that is communicatively coupled over the network 1480. The training computing system 1450 can be separate from the server computing system 1430 or can be a portion of the server computing system 1430.

The training computing system 1450 includes one or more processors 1452 and a memory 1454. The one or more processors 1452 can be any suitable processing device (e.g., a processor core, a microprocessor, an ASIC, a FPGA, a controller, a microcontroller, etc.) and can be one processor or a plurality of processors that are operatively connected. The memory 1454 can include one or more non-transitory computer-readable storage mediums, such as RAM, ROM, EEPROM, EPROM, flash memory devices, magnetic disks, etc., and combinations thereof. The memory 1454 can store data 1456 and instructions 1458 which are executed by the processor 1452 to cause the training computing system 1450 to perform operations. In some implementations, the training computing system 1450 includes or is otherwise implemented by one or more server computing devices.

The training computing system 1450 can include a model trainer 1460 that trains the machine-learned models 1420 and/or 1440 stored at the user computing system 1402 and/or the server computing system 1430 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 1460 can perform a number of generalization techniques (e.g., weight decays, dropouts, etc.) to improve the generalization capability of the models being trained.

In particular, the model trainer 1460 can train the machine-learned models 1420 and/or 1440 based on a set of training data 1462. The training data 1462 can include, for example, a domain-specific training dataset that may include a plurality of input examples (e.g., press releases, experimental data, etc.) and a plurality of respective domain-specific content items. The plurality of respective domain-specific content items can include example domain-specific content items (e.g., example news articles, example research papers, etc.). The plurality of domain-specific content items can include one or more domain-specific attributes.

Training can include utilizing and/or interfacing with a domain-specific database 1470. The user computing system 1402, the server computing system 1430, and/or the training computing system 1450 may communicate with the domain-specific database 1470 via the network 1480. Alternatively and/or additionally, the domain-specific database 1470 may be part of the server computing system 1430 and/or the training computing system 1450.

The domain-specific database 1470 can store one or more domain-specific training datasets. The domain-specific database 1470 can include a plurality of content items associated with one or more domains (e.g., one or more fields of expertise (e.g., journalism, physics research papers, literary analysis theses, etc.). In some implementations, the domain-specific database 1470 can include a plurality of input examples, which can include a plurality of example source content datasets. The domain-specific database 1470 can include real-world content items, curated content items, and/or synthetic content items (e.g., model-generated content items).

The domain-specific database 1470 can be generated based on content item owners (e.g., authors, publishers, and/or assignees) submitting their content items to the database. Users can be given the option on whether their content item is utilized for training and/or tuning. The system 1400 can provide users with options on if, when, how, and/or to what extent their content items are utilized. Users can be provided with the option to not provide the content item for storage and/or usage. The domain-specific database 1470 and/or the domain-specific training dataset can be limited to only input examples and/or content items that are received based on permissions provided by the rights holder of the particular input examples and/or content items. The user may direct the system 1400 to only utilize their content during soft prompt tuning. The soft prompts 1424 may then be stored on the user computing system 1402 and/or the prompt library 1442 with restrictions to only be utilized by the particular user. Rights holders and/or users can rescind their permissions, which can then cause the adjustment of if, when, how, and/or to what extent their content is utilized (which may include stopping all storage and/or usage).

The system 1400 can leverage evaluation signals, filtering, and/or loss functions to train and/or configure the system to ensure that model-generated content items are not plagiarizing content items from the domain-specific database 1470 and/or the domain-specific training dataset.

An example machine-learned model can include a generative model (e.g., a large language model, a foundation model, a vision language model, an image generation model, a text-to-image model, an audio generation model, and/or other generative models).

Training and/or tuning the machine-learned model can include obtaining a training instance. A set of training data can include a plurality of training instances divided between multiple datasets (e.g., a training dataset, a validation dataset, or testing dataset). A training instance can be labeled or unlabeled. The runtime inferences can form training instances when a model is trained using an evaluation of the model's performance on that runtime instance (e.g., online training/learning). Example data types for the training instance and various tasks associated therewith are described throughout the present disclosure.

Training and/or tuning can include processing, using one or more machine-learned models, the training instance to generate an output. The output can be directly obtained from the one or more machine-learned models or can be a downstream result of a chain of processing operations that includes an output of the one or more machine-learned models.

Training and/or tuning can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

Training and/or tuning can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Training and/or tuning can include implementing a number of generalization techniques (e.g., weight decays, dropouts, etc.) to improve the generalization capability of the models being trained.

In some implementations, the above training loop can be implemented for training a machine-learned model from an initialized state to a fully trained state (e.g., when the model exhibits a desired performance profile, such as based on accuracy, precision, recall, etc.).

In some implementations, the above training loop can be implemented for particular stages of a training procedure. For instance, in some implementations, the above training loop can be implemented for pre-training a machine-learned model. Pre-training can include, for instance, large-scale training over potentially noisy data to achieve a broad base of performance levels across a variety of tasks/data types. In some implementations, the above training loop can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

In some implementations, the one or more machine-learned models (e.g., 1420 and/or 1440) can include one or more generative models to generate a model-generated content item that can then be provided to a user. The generation may be prompted based on a user selection and/or may be automatically performed (e.g., automatically performed based on one or more conditions, which may be associated with a threshold amount of search results not being identified).

The one or more generative models can include language models (e.g., large language models and/or vision language models), image generation models (e.g., text-to-image generation models and/or image augmentation models), audio generation models, video generation models, graph generation models, and/or other data generation models (e.g., other content generation models). The one or more generative models can include one or more transformer models, one or more convolutional neural networks, one or more recurrent neural networks, one or more feedforward neural networks, one or more generative adversarial networks, one or more self-attention models, one or more embedding models, one or more encoders, one or more decoders, and/or one or more other models. In some implementations, the one or more generative models can include one or more autoregressive models (e.g., a machine-learned model trained to generate predictive values based on previous behavior data) and/or one or more diffusion models (e.g., a machine-learned model trained to generate predicted data based on generating and processing distribution data associated with the input data).

The one or more generative models can be trained to process input data and generate model-generated content items, which may include a plurality of predicted words, pixels, signals, and/or other data. The model-generated content items may include novel content items that are not the same as any pre-existing work. The one or more generative models can leverage learned representations, sequences, and/or probability distributions to generate the content items, which may include phrases, storylines, settings, objects, characters, beats, lyrics, and/or other aspects that are not included in pre-existing content items.

The one or more generative models may include a vision language model. The vision language model can be trained, tuned, and/or configured to process image data and/or text data to generate a natural language output. The vision language model may leverage a pre-trained large language model (e.g., a large autoregressive language model) with one or more encoders (e.g., one or more image encoders and/or one or more text encoders) to provide detailed natural language outputs that emulate natural language composed by a human.

The vision language model may be utilized for zero-shot image classification, few shot image classification, image captioning, multimodal query distillation, multimodal question and answering, and/or may be tuned and/or trained for a plurality of different tasks. The vision language model can perform visual question answering, image caption generation, feature detection (e.g., content monitoring (e.g., for inappropriate content)), object detection, scene recognition, and/or other tasks.

The vision language model may leverage a pre-trained language model that may then be tuned for multimodality. Training and/or tuning of the vision language model can include image-text matching, masked-language modeling, multimodal fusing with cross attention, contrastive learning, prefix language model training, and/or other training techniques. For example, the vision language model may be trained to process an image to generate predicted text that is similar to ground truth text data (e.g., a ground truth caption for the image). In some implementations, the vision language model may be trained to replace masked tokens of a natural language template with textual tokens descriptive of features depicted in an input image. Alternatively and/or additionally, the training, tuning, and/or model inference may include multi-layer concatenation of visual and textual embedding features. In some implementations, the vision language model may be trained and/or tuned via jointly learning image embedding and text embedding generation, which may include training and/or tuning a system to map embeddings to a joint feature embedding space that maps text features and image features into a shared embedding space. The joint training may include image-text pair parallel embedding and/or may include triplet training. In some implementations, the images may be utilized and/or processed as prefixes to the language model.

The one or more generative models may be stored on-device and/or may be stored on a server computing system. In some implementations, the one or more generative models can perform on-device processing to determine suggested searches, suggested actions, and/or suggested prompts. The one or more generative models may include one or more compact vision language models that may include less parameters than a vision language model stored and operated by the server computing system. The compact vision language model may be trained via distillation training. In some implementations, the visional language model may process the display data to generate suggestions. The display data can include a single image descriptive of a screenshot and/or may include image data, metadata, and/or other data descriptive of a period of time preceding the current displayed content (e.g., the applications, images, videos, messages, and/or other content viewed within the past 30 seconds). The user computing device may generate and store a rolling buffer window (e.g., 30 seconds) of data descriptive of content displayed during the buffer. Once the time has elapsed, the data may be deleted. The rolling buffer window data may be utilized to determine a context, which can be leveraged for query, content, action, and/or prompt suggestion.

In some implementations, the generative models can include machine-learned sequence processing models. An example system can pass inputs to sequence processing models. Sequence processing models can include one or more machine-learned components. Sequence processing models can process the data from inputs to obtain an input sequence. Input sequence can include one or more input elements obtained from inputs. The sequence processing model can process the input sequence using prediction layers to generate an output sequence. The output sequence can include one or more output elements generated based on input sequence. The system can generate outputs based on output sequence.

Sequence processing models can include one or multiple machine-learned model components configured to ingest, generate, or otherwise reason over sequences of information. For example, some example sequence processing models in the text domain are referred to as “Large Language Models,” or LLMs. See, e.g., “PaLM 2 Technical Report,” Google, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, arXiv:2010.11929v2 (Jun. 3, 2021), audio domains, see, e.g., Agostinelli et al., MusicLM: Generating Music From Text, arXiv:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing models can process one or multiple types of data simultaneously. Sequence processing models can include relatively large models (e.g., more parameters, computationally expensive, etc.), relatively small models (e.g., fewer parameters, computationally lightweight, etc.), or both.

In general, sequence processing models can obtain an input sequence using data from inputs. For instance, input sequence can include a representation of data from inputs in a format understood by sequence processing models. One or more machine-learned components of sequence processing models can ingest the data from inputs, parse the data into pieces compatible with the processing architectures of sequence processing models (e.g., via “tokenization”), and project the pieces into an input space associated with prediction layers (e.g., via “embedding”).

Sequence processing models can ingest the data from inputs and parse the data into a sequence of elements to obtain input sequence. For example, a portion of input data from inputs can be broken down into pieces that collectively represent the content of the portion of the input data. The pieces can provide the elements of the sequence.

In some implementations, processing the input data can include tokenization. For example, a tokenizer may process a given portion of an input source and output a series of tokens (e.g., corresponding to input elements) that represent the portion of the input source. Various approaches to tokenization can be used. For instance, textual input sources can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66-71 (October 31-Nov. 4, 2018), https://aclanthology.org/D18-2012.pdf. Image-based input sources can be tokenized by extracting and serializing patches from an image.

In general, arbitrary data types can be serialized and processed into an input sequence.

Prediction layers can predict one or more output elements based on the input elements. Prediction layers can include one or more machine-learned model architectures, such as one or more layers of learned parameters that manipulate and transform the inputs to extract higher-order meaning from, and relationships between, input elements. In this manner, for instance, example prediction layers can predict new output elements in view of the context provided by input sequence.

Prediction layers can evaluate associations between portions of input sequence and a particular output element. These associations can inform a prediction of the likelihood that a particular output follows the input context. For example, consider the textual snippet, “The carpenter's toolbox was small and heavy. It was full of ___.” Example prediction layers can identify that “It” refers back to “toolbox” by determining a relationship between the respective embeddings. Example prediction layers can also link “It” to the attributes of the toolbox, such as “small” and “heavy. ” Based on these associations, prediction layers can, for instance, assign a higher probability to the word “nails” than to the word “sawdust.”

A transformer is an example architecture that can be used in prediction layers. See, e.g., Vaswani et al., Attention Is All You Need, arXiv:1706.03762v7 (Aug. 2, 2023). A transformer is an example of a machine-learned model architecture that uses an attention mechanism to compute associations between items within a context window. The context window can include a sequence that contains input sequence and potentially one or more output elements. A transformer block can include one or more attention layers and one or more post-attention layers (e.g., feedforward layers, such as a multi-layer perceptron).

Prediction layers can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layers can leverage various kinds of artificial neural networks that can understand or generate sequences of information.

Output sequence can include or otherwise represent the same or different data types as input sequence. For instance, input sequence can represent textual data, and output sequence can represent textual data. The input sequence can represent image, audio, or audiovisual data, and output sequence can represent textual data (e.g., describing the image, audio, or audiovisual data). It is to be understood that prediction layers, and any other interstitial model components of sequence processing models, can be configured to receive a variety of data types in input sequences and output a variety of data types in output sequences.

The output sequence can have various relationships to an input sequence. Output sequence can be a continuation of input sequence. The output sequence can be complementary to the input sequence. The output sequence can translate, transform, augment, or otherwise modify input sequence. The output sequence can answer, evaluate, confirm, or otherwise respond to input sequence. The output sequence can implement (or describe instructions for implementing) an instruction provided via an input sequence.

The output sequence can be generated autoregressively. For instance, for some applications, an output of one or more prediction layers can be passed through one or more output layers (e.g., softmax layer) to obtain a probability distribution over an output vocabulary (e.g., a textual or symbolic vocabulary) conditioned on a set of input elements in a context window. In this manner, for instance, the output sequence can be autoregressively generated by sampling a likely next output element, adding that element to the context window, and re-generating the probability distribution based on the updated context window, and sampling a likely next output element, and so forth.

The output sequence can also be generated non-autoregressively. For instance, multiple output elements of the output sequence can be predicted together without explicit sequential conditioning on each other. See, e.g., Saharia et al., “Non-Autoregressive Machine Translation with Latent Alignments,” arXiv:2004.07437v3 (Nov. 16, 2020).

The output sequence can include one or multiple portions or elements. In an example content generation configuration, the output sequence can include multiple elements corresponding to multiple portions of a generated output sequence (e.g., a textual sentence, values of a discretized waveform, computer code, etc.). In an example classification configuration, the output sequence can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

In some implementations, if the user has provided consent, the training examples can be provided by the user computing system 1402. Thus, in such implementations, the model 1420 provided to the user computing system 1402 can be trained by the training computing system 1450 on user-specific data received from the user computing system 1402. In some instances, this process can be referred to as personalizing the model.

The model trainer 1460 includes computer logic utilized to provide desired functionality. The model trainer 1460 can be implemented in hardware, firmware, and/or software controlling a general purpose processor. For example, in some implementations, the model trainer 1460 includes program files stored on a storage device, loaded into a memory and executed by one or more processors. In other implementations, the model trainer 1460 includes one or more sets of computer-executable instructions that are stored in a tangible computer-readable storage medium such as RAM hard disk or optical or magnetic media.

The network 1480 can be any type of communications network, such as a local area network (e.g., intranet), wide area network (e.g., Internet), or some combination thereof and can include any number of wired or wireless links. In general, communication over the network 1480 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be audio compression task. The input may include audio data and the output may include compressed audio data. In another example, the input includes visual data (e.g., one or more images or videos), the output can include compressed visual data, and the task is a visual data compression task. In another example, the task may include generating an embedding for input data (e.g., input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may include a text output which is mapped to the spoken utterance. In some cases, the task may include encrypting or decrypting input data. In some cases, the task can include a microprocessor performance task, such as branch prediction or memory address translation.

In some implementations, the task can be a generative task, and the one or more machine-learned models (e.g., 1420 and/or 1440) can be configured to output content generated in view of one or more inputs. For instance, the inputs can be or otherwise represent data of one or more modalities that encodes context for generating additional content.

In some implementations, the task can be a text completion task. The machine-learned models can be configured to process the inputs that represent textual data and to generate the outputs that represent additional textual data that completes a textual sequence that includes the inputs. For instance, the machine-learned models can be configured to generate the outputs to complete a sentence, paragraph, or portion of text that follows from a portion of text represented by inputs.

In some implementations, the task can be an instruction following task. The machine-learned models can be configured to process the inputs that represent instructions to perform a function and to generate the outputs that advance a goal of satisfying the instruction function (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the instructions (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the instructions (e.g., natural language responses, programming language responses, machine language responses, etc.). One or more outputs can be iteratively or recursively generated to sequentially process and accomplish steps toward accomplishing the requested functionality. For instance, an initial output can be executed by an external system or be processed by the machine-learned models to complete an initial step of performing a function. Multiple steps can be performed, with a final output being obtained that is responsive to the initial instructions.

In some implementations, the task can be a question answering task. The machine-learned models can be configured to process the inputs that represent a question to answer and to generate the outputs that advance a goal of returning an answer to the question (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the question (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the question (e.g., natural language responses, programming language responses, machine language responses, etc.). One or more outputs can be iteratively or recursively generated to sequentially process and accomplish steps toward answering the question. For instance, an initial output can be executed by an external system or be processed by the machine-learned models to complete an initial step of obtaining an answer to the question (e.g., querying a database, performing a computation, executing a script, etc.). Multiple steps can be performed, with a final output being obtained that is responsive to the question.

In some implementations, the task can be an image generation task. The machine-learned models can be configured to process the inputs that represent context regarding a desired portion of image content. The context can include text data, image data, audio data, etc. Machine-learned models can be configured to generate the outputs that represent image data that depicts imagery related to the context. For instance, the machine-learned models can be configured to generate pixel data of an image. Values for channels associated with the pixels in the pixel data can be selected based on the context (e.g., based on a probability determined based on the context).

In some implementations, the task can be an audio generation task. Machine-learned models can be configured to process the inputs that represent context regarding a desired portion of audio content. The context can include text data, image data, audio data, etc. The machine-learned models can be configured to generate the outputs that represent audio data related to the context. For instance, the machine-learned models can be configured to generate waveform data in the form of an image (e.g., a spectrogram). Values for channels associated with pixels of the image can be selected based on the context. The machine-learned models can be configured to generate waveform data in the form of a sequence of discrete samples of a continuous waveform. Values of the sequence can be selected based on the context (e.g., based on a probability determined based on the context).

In some implementations, the task can be a data generation task. Machine-learned models can be configured to process the inputs that represent context regarding a desired portion of data (e.g., data from various data domains, such as sensor data, image data, multimodal data, statistical data, etc.). The desired data can be, for instance, synthetic data for training other machine-learned models. The context can include arbitrary data types. The machine-learned models can be configured to generate the outputs that represent data that aligns with the desired data. For instance, the machine-learned models can be configured to generate data values for populating a dataset. Values for the data objects can be selected based on the context (e.g., based on a probability determined based on the context).

FIG. 14 illustrates one example computing system that can be used to implement the present disclosure. Other computing systems can be used as well. For example, in some implementations, the user computing system 1402 can include the model trainer 1460 and the training dataset 1462. In such implementations, the models 1420 can be both trained and used locally at the user computing system 1402. In some of such implementations, the user computing system 1402 can implement the model trainer 1460 to personalize the models 1420 based on user-specific data.

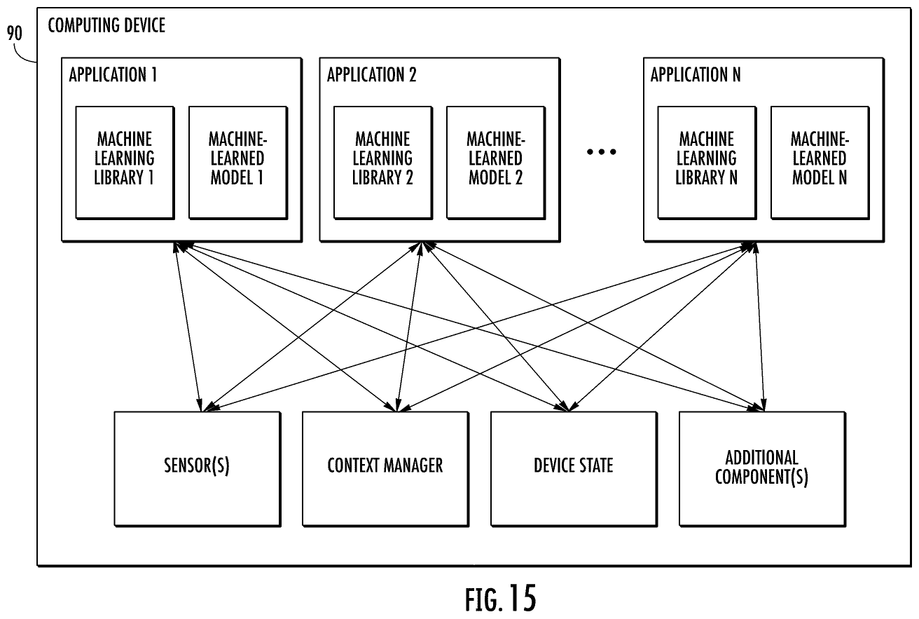

FIG. 15 depicts a block diagram of an example computing device 90 that performs according to example embodiments of the present disclosure. The computing device 90 can be a user computing device or a server computing device.

The computing device 90 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 15, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

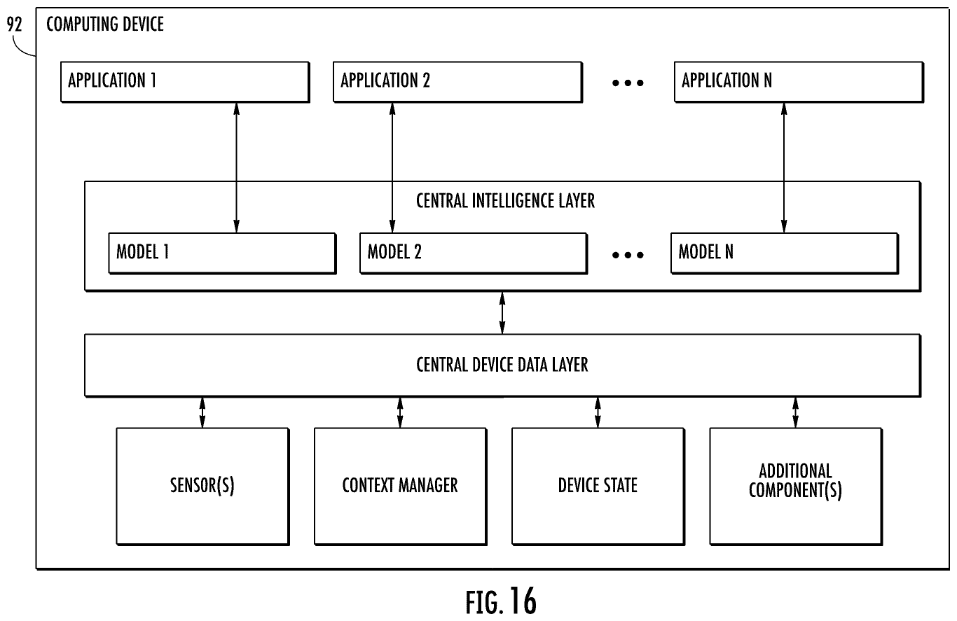

FIG. 16 depicts a block diagram of an example computing device 92 that performs according to example embodiments of the present disclosure. The computing device 92 can be a user computing device or a server computing device.

The computing device 92 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 16, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 92.

The central intelligence layer can communicate with a central device data layer. The central device data layer can be a centralized repository of data for the computing device 92. As illustrated in FIG. 16, the central device data layer can communicate with a number of other components of the computing device, such as, for example, one or more sensors, a context manager, a device state component, and/or additional components. In some implementations, the central device data layer can communicate with each device component using an API (e.g., a private API).

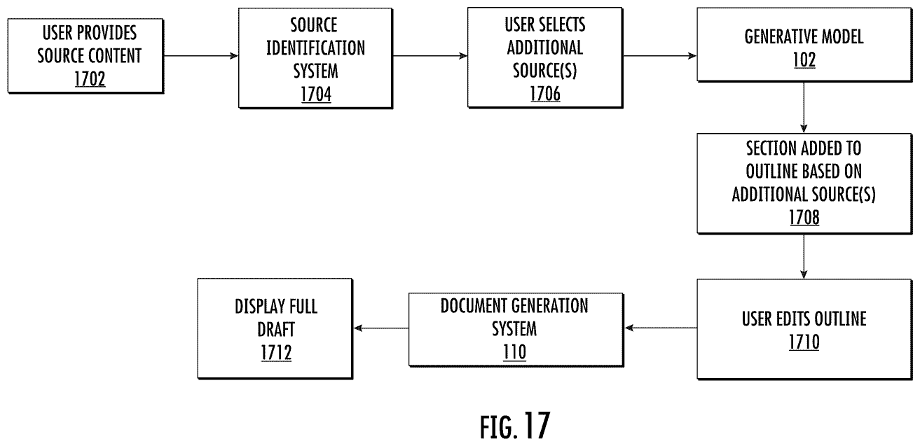

FIG. 17 depicts a flow diagram of an example process for adding additional sources to a system for content generation system 100 according to example embodiments of the present disclosure. In some implementations, a user can, at 1702, provide source content to the content generation system. As discussed above, the content generation system can generate an outline based on the provided content source. The content generation system can include a source identification system 1704. The source identification system can use the source content provided by the user to identify one or more supplemental or additional sources.

These additional sources can serve a specific purpose, providing further details about the subject of the source content. They can also offer background information to elucidate concepts in the source content that may not be fully explained based on the source content alone. Furthermore, they may bring in additional news that was not deemed newsworthy enough to be included in the source content.

The user can, by selecting an interface element in the user interface, view the list of additional sources. The user can review each additional source, determine whether it might have useful information for the content they are generating, and add additional sources through the user interface. In this way, the user can identify sources that provide additional information that is not in the source content itself.

The additional sources can be provided to the generative model 102. The generative model can, at 1708, add a section to the outline based on the sources. In some examples, the user interface can indicate which sections are from the original source content and which sources are from additional sources. For example, the user interface can have a line connecting each section to the document from which it was sourced.

The user can, at 1710, edit the displayed outline. Editing can include adding or removing information, changing the grammar or language use, and changing the order of the sections as needed. Once the user has entered the outline, at 1710, the document generation system 110 can generate a full draft based on the outline. The user interface can, at 1712, display the full draft. The full draft can include information describing the source for each portion of the full draft. For example, the user interface can include a line or arrow that connects each portion of the draft with the source from which it was retrieved.

The technology discussed herein makes reference to servers, databases, software applications, and other computer-based systems, as well as actions taken and information sent to and from such systems. The inherent flexibility of computer-based systems allows for a wide variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method, the method comprising:
obtaining, by a computing system comprising one or more processors, input data, wherein the input data comprises source content that comprises a set of details associated with a topic;
processing, by the computing system, the input data with a generative model to generate one or more candidate model-generated outputs;
displaying, by the computing system, a respective candidate model output in a user interface, wherein the user interface includes visual indicia of one or more signals associated with content in the candidate model output;
receiving, by the computing system, augmentation input based on interaction with the user interface; and
updating, by the computing system, the displayed respective candidate model output based on the augmentation input.

2. The computer-implemented method of claim 1, wherein each respective candidate model output is a candidate outline of a document based on the input data.

3. The computer-implemented method of claim 2, the method further comprising:
generating, by the computing system, a complete document based on the candidate outline.

4. The computer-implemented method of claim 2, the method further comprising:
receiving, by the computing system, a user approval input for the candidate outline; and
in response to receiving the user approval input, updating the user interface to display a full document generated based on the candidate outline.

5. The computer-implemented method of claim 4, wherein the outline includes a plurality of sections, each section representing a portion of the document.

6. The computer-implemented method of claim 5, wherein the plurality of sections includes one section associated with an article lede and one or more sections associated with one or more article paragraphs.

7. The computer-implemented method of claim 6, wherein the user approval input is associated with one respective section of the outline and the method further comprises:
generating, by the computing system, only a portion of the full draft associated with the one respective section.

8. The computer-implemented method of claim 5, wherein the outline and the source content are displayed simultaneously in the user interface.

9. The computer-implemented method of claim 8, wherein the visual indicia include an interface object connecting a particular portion of the outline with a source from the source content.

10. The computer-implemented method of claim 8, wherein the visual indicia include underlining and highlighting of text.

11. The computer-implemented method of claim 4, wherein the full document and the source content are displayed simultaneously in the user interface.

12. The computer-implemented method of claim 11, wherein the full document includes visual indicia of one or more signals associated with content in the full document and the he visual indicia include an interface object connecting a particular portion of the full document with a source from the source content.

13. The computer-implemented method of claim 2, wherein the user input includes textual edits to the outline.

14. The computer-implemented method of claim 2, wherein the signals can include one or more of: a grounding signal, a length signal, a recitation signal, an attribution accuracy signal, an incorrect quote signal, and a verbatim signal.

15. The computer-implemented method of claim 2, wherein the document is a news article.

16. The computer-implemented method of claim 1, wherein the generative model was tuned on a domain-specific training dataset associated with journalism, wherein the domain-specific training dataset comprises a plurality of news articles comprising a particular information structure and a particular set of publication type-specific stylistic characteristics.

17. The computer-implemented method of claim 2, wherein the augmentation input is descriptive of an additional topic to add to the model output, and wherein the updated candidate model output comprises an additional section associated with the additional topic.

18. The computer-implemented method of claim 2, wherein the augmentation input is descriptive of a change in an order structure of the candidate model output, and wherein the candidate model output comprises an updated order structure.

19. A computing device, the computing device comprising:
one or more processors; and
a computer-readable memory, wherein the computer-readable memory stores instructions that, when executed by the one or more processors, cause the computing device to perform operations comprising:
obtaining input data, wherein the input data comprises source content that comprises a set of details associated with a topic;
processing the input data with a generative model to generate one or more candidate model-generated outputs;
displaying a respective candidate model output in a user interface, wherein the user interface includes visual indicia of one or more signals associated with content in the candidate model output;
receiving augmentation input based on interaction with the user interface; and
updating the displayed respective candidate model output based on the augmentation input.

20. A non-transitory computer-readable medium storing instructions that, when executed by one or more computing devices, cause the one or more computing devices to perform operations comprising:
obtaining input data, wherein the input data comprises source content that comprises a set of details associated with a topic;
processing the input data with a generative model to generate one or more candidate model-generated outputs;
displaying a respective candidate model output in a user interface, wherein the user interface includes visual indicia of one or more signals associated with content in the candidate model output;
receiving augmentation input based on interaction with the user interface; and
updating the displayed respective candidate model output based on the augmentation input.
